(19) United States
(12) Patent Application Publication
(10) Pub. No.: US 2001/0043884 A1
(43) Pub. Date: Nov. 22, 2001

(54) Microwave unit and system for tissue processing

(76) Inventors: Ervin Essenfeld, Caracas (VE); Harold Essenfeld, Caracas (VE); Ali R. Shahin, Coral Gables, FL (US); Harold D. Kimrey, Knoxville, TN (US); Azorides R. Morales, Miami, FL (US)

Correspondence Address: PILLSBURY WINTHROP LLP, 1600 TYSONS BOULEVARD, MCLEAN, VA, 22102, US

(21) Appl. No.: 09/735,914

(22) Filed: Dec. 14, 2000

Related U.S. Application Data
(60) Provisional application No. 60/170,545, filed on Dec. 14, 1999.

(51) Int. Cl. B32B 5/02; B32B 27/04; B32B 27/12

(52) U.S. Cl. 422/99; 422/68.1

(57) ABSTRACT

An improved microwave unit and system incorporating the unit are provided for use in tissue processing and other chemical reactions. The microwave unit is comprised of an energy source, a wavguide transmitting the microwave energy to a reaction chamber, and the reaction chamber being adapted to perform the desired chemical reaction. The unit provides gentle and uniform heating, with minimal heat loss and escape of volatile chemicals. The system may be operated continuously or batchwise, by manual operation or automatically. Preferably, an automated system is operated with continuous throughput using a robotic armature to obtain the advantages of the invention.

### RELATED APPLICATIONS

This application claims priority benefit to provisional U.S. Appln. No. 60/170,545 which was filed Dec. 14, 1999 and is still pending. Moreover, this application is also related to U.S. application Ser. No. 09/136,292, filed Aug. 19, 1998, which claimed priority benefit to U.S. Appln. No. 60/056,102, filed Aug. 20, 1997.

### BACKGROUND OF THE INVENTION

1. Field of the Invention

The present invention relates to the rapid, continuous flow, processing of tissue for microscopic examination, from fixation to impregnation. In particular, it relates to an improved microwave unit and a system, capable of manual or automated use, to accomplish this tissue processing. Preferably, the tissue processing system is operated in a continuous manner.

2. Description of the Related Art

Conventional methods prepare tissues for histology by incubation in separate solutions of phosphate-buffered 10% formaldehyde for fixation, a series of increasing concentrations of ethanol for dehydration, and xylene for clearing tissue of dehydration agent, prior to impregnation. Because of the time required for this process, usually 8 hours or longer, it is customary to complete these separate steps—fixation, dehydration, clearing, and impregnation—overnight in automated mechanical instruments designed for those tasks (see, for example, U.S. Pat. Nos. 3,892,197; 4,141,312; and 5,049,510).

Automated tissue processors implementing such conventional processes are manufactured and sold by, for example, Shandon (HYPERCENTER and PATHCENTRE models), Miles-Sakura (TISSUE-TEK models), and Mopec-Medite (TPC15 model).

A disadvantage of the prior art is that such automated systems have not been capable of continuous throughput. Given the time required to complete tissue processing, cassettes containing tissues are loaded into the system during the day and tissue processing is completed in an overnight cycle. Thus, operation of the prior art systems did not allow tissue-containing cassettes to be processed to completion during the work day, with further cassettes being initially processed before cassettes that have been previously loaded were completely processed.

For example, the TISSUE-TEK vacuum infiltration processor (VIP) series requires more than eight hours for completion of processing. Baskets holding the cassettes are placed in a retort in which tissue is processed. In addition, 14 stations supply solutions of various compositions to the retort. User-programmable software controls this automated process. A rotary valve regulates the movement of solutions between the retort and the various stations; apply pressure or vacuum to the retort when the valve is open causes solution to be pumped out of or pumped into the retort, respectively. Upon completion of a processing run, the instrument automatically prompts the use for a cleaning cycle; this requirement can be overridden only if no paraffin is used. Typically, tissue specimens are batch processed according to the following program:

| | | | Set | Set | | | Vol. |
|---|---|---|---|---|---|---|---|
| | | Concen- | Time | Tempe- | P/V | Agita- | of |
| Sta. | Solution | tration | (min) | rature | ** | tion | Solution |
| 1 | Buffered | 10% | 50 | 40° C. | On | On | 2.2-3.2 L |
| | formalin | | | | | | |
| 2 | Buffered | 10% | 50 | 40° C. | On | On | 2.2-3.2 L |
| | formalin | | | | | | |
| 3 | Alcohol* | 80% | 50 | 40° C. | On | On | 2.2-3.2 L |
| 4 | Alcohol | 95% | 50 | 40° C. | On | On | 2.2-3.2 L |
| 5 | Alcohol | 95% | 50 | 40° C. | On | On | 2.2-3.2 L |
| 6 | Alcohol | 100% | 50 | 40° C. | On | On | 2.2-3.2 L |
| 7 | Alcohol | 100% | 50 | 40° C. | On | On | 2.2-3.2 L |
| 8 | Alcohol | 100% | 50 | 40° C. | On | On | 2.2-3.2 L |
| 9 | Xylene | 100% | 50 | 40° C. | On | On | 2.2-3.2 L |
| 10 | Xylene | 100% | 50 | 40° C. | On | On | 2.2-3.2 L |
| 11 | Paraffin | | 50 | 60° C. | On | On | 4 L |
| 12 | Paraffin | | 50 | 60° C. | On | On | 4 L |
| 13 | Paraffin | | 50 | 60° C. | On | On | 4 L |
| 14 | Paraffin | | 50 | 60° C. | On | On | 4 L |

**-P/V (Pressure/Vacuum): Agitation is provided by alternating the application of pressure and vacuum to the retort when “P/V” is On. Otherwise, when “Agitation” is On, agitation can also be provided by pumping in and then pumping out the same solution every 20 minutes.
*-The alcohol used on most laboratories is a mixture of 90% ethyl, 5% methyl, and 5% isopropyl alcohol.

Typically such conventional methodology demands sending tissue specimens from the operating room, medical office or other sites, to a pathology laboratory sometime during the working day; overnight batch processing of the specimens, so that a tissue specimen suitable for blocking and sectioning is only available on the morning of the next day; and rendering a diagnosis by a pathologist based on microscopic examination of sections prepared from a blocked and sectioned specimen later on that next day (FIG. 1). This requires almost 24 hours between receipt of the specimen and delivery of the pathologist's report.

In addition to the minimum one-day delay in giving a surgeon the benefit of a report from the pathologist, there are also problems associated with impeded work flow in the pathology laboratory necessitated by the requisite batch processing of specimens, the safety concerns that attend having instruments operating overnight, the risk of possible instrument failures and the need to monitor the instruments, and the waste of using large volumes of reagents for such processing when automated. Moreover, expensive measures are required to prevent exposure of laboratory personnel to noxious fumes and toxic substances associated with the reagents used in this process. Also, the large volumes of solvent waste and paraffin debris produced by the conventional methodology will pollute the environment if not properly disposed.

Conventional fixation and processing also cause irreversible damage (e.g., hydrolysis of a phosphodiester bond and/or deamidation) to the structure of nucleic acids (e.g., DNA, and especially RNA) that limits the application of genetic techniques for diagnosis and research. Consequently, most DNA and certainly RNA analysis require special precautions with handling of material, such as immediate freezing of fresh tissues to prevent degradation, because retrospective genetic analysis is impaired by the conventional methodology.

Histological diagnosis of a frozen section suffers from multiple disadvantages in comparison to sections prepared from paraffin blocks. U.S. Pat. No. 3,961,097 cautions that the slide prepared from a frozen section “does not possess uniformity of quality;” “it is technically more difficult for serial sections of the same specimen to be examined;” “extreme caution must be exercised in cutting the specimen in order to ensure a sufficiently thin section and to avoid the possibility of damaging details of the specimen;” and all the slides must be prepared “while the tissue is in the initial frozen state” because “[i]f the tissue is thawed and refrozen for sectioning, it is severely damaged.”

There is an ever present interest in expediting tissue processing and analysis for diagnostic purposes. Furthermore, recent healthcare focus has been directed to lessening the cost of various procedures including tissue processing. The costs of tissue processing are related to the time for processing and analysis of the specimens, the space required for the personnel and equipment in the laboratory, the volume of reagents (both the purchase price of the pure chemicals and the charges for discarding waste), and the number of personnel required. More importantly, patients and their physicians depend on evaluation and diagnosis by the pathologist to guide treatment. Reducing the amount of time needed to complete tissue processing would lessen the anxiety experienced during the period between obtaining the specimen and delivering the pathologist's report to the surgeon.

Others have recognized the need to shorten the time required for tissue processing, but they have made only modest improvements in the conventional methods. To accelerate tissue processing, U.S. Pat. Nos. 4,656,047, 4,839,194, and 5,244,787 use microwave energy; U.S. Pat. Nos. 3,961,097 and 5,089,288 use ultrasonic energy; and U.S. Pat. No. 5,023,187 uses infrared energy. U.S. Pat. No. 5,104,640 disclosed a non-aqueous composition of a fixative, a stabilizing agent, and a solubilizing agent that adheres a blood smear to a slide. However, the aforementioned patents do not teach or suggest that the entire process of preparing diagnostic tissue slides could be accomplished in less than two hours, starting from fixation and ending with impregnation, with continuous processing of specimens. We disclosed such a process in application Ser. No. 09/136,292, filed Aug. 19, 1998, and Apppln. No. 60/056,102, filed Aug. 20, 1997.

Microwave ovens similar in design to those used in home cooking have been used to accelerate the time required for tissue processing. U.S. Pat. No. 4,656,047 claims a method of tissue processing in which at least one of the dehydrating, clearing, or impregnating steps utilizes microwave energy. Fixation may be accomplished by immersing the tissue specimen in chemical fixative and then exposing the specimen to microwave energy for a time sufficient to chemically fix the specimen. U.S. Pat. No. 4,839,194 claims a method of fixing a tissue specimen at a temperature not to exceed 40° C. in which the non-thermal effects of microwave energy are used. U.S. Pat. Nos. 4,839,194 and 5,244,787 claim a method of staining tissue specimens utilizing microwave energy.

In such conventional methods of tissue processing, it has been recognized that the distribution of microwave energy is not uniform because of reflection and interference effects; within the chamber in which the microwaves resonate and the waveguide that conducts the microwaves from the source to the chamber. U.S. Pat. No. 4,835,354 proposes a mechanical solution utilizing a rotating platform to ensure uniform contact with the microwaves, and mixers and isolaters that disperse and absorb microwaves. U.S. Pat. No. 5,289,140 proposes a solution that utilizes a combination of microwaves of different wavelengths and/or intensities, or sources emitting microwaves of different frequencies. U.S. Pat. No. 5,796,080 discloses adjustable moderating means between the waveguide and a plurality of resonance chambers to individually control the chemical reaction in each chamber, such that the propagated mode of the microwaves in the waveguide is not substantially changed.

We now describe a microwave unit that provides gentle uniform heating during tissue processing in a manner distinct from that disclosed in the aforementioned patents. Such operation causes minimal damage to the processed tissue, and results in a superior specimen for subsequent histologic studies by a pathologist or cell biologist. In contrast to the solutions disclosed in the patent discussed above, our microwave unit does not use a resonance chamber. This is an important consideration when heating a region that is larger in all dimensions than about 10%-20% of the wavelength of the microwaves used. In the invention, microwave energy is distributed into the solution and tissue in such a way as to minimize interference effects. By distributing the energy, it is absorbed by the solution and tissue in one pass through the materials.

Some improvements that result from the invention are summarized here, but other improvements are described below. Convective heat losses from the reaction chamber and the evaporation rate of liquid in the reaction chamber are reduced, volatile substances are prevented from contacting electronic components and vented to protect the laboratory personnel in the vicinity of the unit, errors committed during processing by a human operator are eliminated, the power required by the unit to maintain the liquid temperature in the reaction chamber is reduced, and labor and reagent costs are reduced with this system as compared to manual operation. More subjectively, consistency in the quality of tissue specimens processed by the disclosed process is improved. Although one microwave unit may be used advantageously, multiple units may be operationally and physically linked to accelerate chemical reactions performed in batch or continuous mode.

The novel microwave unit disclosed herein may be used in our process for tissue processing or other histochemical reactions. The process may be practiced manually or automatically with appropriate instrumentation.

### SUMMARY OF THE INVENTION

It is an object of the invention to provide a microwave unit and a system for tissue processing that reduces the time required for processing and analysis, and reduces the cost thereof. The tissue processing system is capable of automation and, preferably, accepts specimens in a continuous manner. This allows conversion of existing practice to rapid response surgical pathology for the patient undergoing an operation, and may even allow point-of-care diagnosis by the pathologist in the vicinity of the operating room.

In particular, the microwave unit can provide gentle heating of tissue specimens and prevents over cooking. Uniform heating in the reaction chamber ensures specimens at different locations in the chamber are maintained at about the same temperature. Thus, both the temperature throughout the chamber and during steps of the process are kept substantially the same. A preferred configuration for the chamber is built in whispering gallery mode. Disadvantages of conventional microwave ovens are avoided by the invention.

The continuous system for tissue processing may utilize the microwave unit as at least one module of the system. Such system may be manually operated or automated. Tissue specimens may be loaded into the system and processed either continuously or batchwise; continuous processing is preferred. The system may be adapted for use in the process described in U.S. Appln. No. 60/056,102 and Ser. No. 09/136,292; or in other histochemical reactions.

A microwave unit of the invention is comprised of: (a) a source of microwave energy, (b) a waveguide that transmits the microwave energy from the source to a reaction chamber, and (c) a reaction chamber that receives the transmitted microwave energy and is adapted to process a tissue specimen by at least chemical fixation, dehydration, and defatting. The reaction chamber may contain a plurality of different tissue specimens. Preferably, the interior geometry of the reaction chamber is configured to achieve uniform distribution of microwave energy and heating of its contents. Similarly, the source and the waveguide are configured to achieve minimal energy loss during transmission of the microwave radiation. It is also preferred that power delivered by the microwave source, and thus the heating of the reaction chamber's contents, is regulated by a variable current source to allow continuous variation of the power.

The microwave unit may be further comprised of any combination of a removable container adapted to fit in the reaction chamber and to receive at least one tissue specimen; at least one temperature and/or pressure probe to monitor conditions in the reaction chamber; at least one energy probe to monitor microwave energy at the source, in the waveguide, and/or in the reaction chamber; a closure adapted to fit the reaction chamber and to isolate the reaction chamber from the operator's surroundings; thermal insulation to retain heat in the reaction chamber; a seal to isolate electronic components from chemicals in the reaction chamber; and control circuitry to receive input from at least one probe or timer, and to regulate the microwave energy emanating from the source.

The system for tissue processing of the invention comprises a physically linked series of modules (e.g., reaction chambers with or without an operably linked microwave unit) to accomplish a combination of fixation, dehydration, defatting, clearing, and/or impregnation of a tissue specimen. The system may be comprised of one module or a plurality of them. Each module would constitute a part of the entire processing cycle, but an individual module may accomplish more than one of the listed steps (i.e., fixation, dehydration, defatting, clearing, and impregnation) of tissue processing because of the chemical composition contained therein. A recorder may be included to receive measurements of reaction conditions in at least one module and other performance characteristics of the system (e.g., amount of chemical in a module, time spent by a tissue specimen within a module or in contact with a chemical), and to store the measurements for retrieval by the operator.

For batch processing, the modules may occupy the same space and/or the tissue specimen may remain stationary. Microwave or thermal energy may be regulated and transmitted into the same space, or onto the stationary tissue specimen at different times in the process. Chemical solutions and/or vapors may be moved into or out of the same space, or brought into or out of contact with the stationary tissue specimen. It would be preferred to minimize space requirements for the system by using a single reaction chamber and transporting the different chemical compositions into the reaction chamber by tubing or piping from separate storage tanks. A controller can receive input from the reaction chamber and/or from timing that part of the processing cycle, and thereby regulate the transport of the different chemical compositions.

For continuous processing, it is preferred to have a plurality of modules containing at least four, five, or six different chemical compositions and to have at least one armature or track conveyance to move the tissue specimens among the modules. The system will preferably be comprised of at least one, two, or three microwave units. In preferred embodiments of the invention, if a tissue specimen is transferred from one chemical composition to another with the same chemical composition, it may be possible to combine these parts of the processing cycle into the same module with an exchange of the chemical composition therein. Thus, certain parts of the processing cycle may be combined and the number of different modules that are required could be reduced. Plumbing for fluid transfer may be simplified as compared to a batch processing because, in many of the envisioned embodiments, the chemical composition may remain in the reaction chamber during the entire processing cycle and be moved into the reaction chamber only at the initiation of the cycle in a filling step, or out of the reaction chamber at the termination of the cycle in a emptying step. Controller circuitry may also be simplified if movement between modules occurs in an integral multiple of a common block of time. Movement of the tissue specimen may be controlled by a program stored in memory such that a carrier or basket loaded with tissue specimens encounters modules in a particular order for set incubation times. It is preferred that the number of different modules, some of which may contain the same chemical composition, be at least any integer from four to ten.

In contrast to the invention, batch processing is required by the prior art because that conventional methodology may take eight hours or longer. In the prior art, specimens are loaded into an automated instrument and cannot be loaded with additional specimens until the entire instrument cycle is completed. All the tissue specimens loaded into the prior art instrument are at the same stage of processing during the entire instrument cycle.

Further advantages of and improvements due to the invention are described below.

### BRIEF DESCRIPTION OF THE DRAWINGS

FIG. 1 is a flow chart showing that almost 24 hours elapse between the time a tissue specimen is obtained by a surgeon and the time a diagnosis by a pathologist can be prepared from microscopic examination of sections of the tissue.

FIG. 2 is a flow chart showing that with the present invention, diagnosis by the pathologist can be made available to the surgeon who provided the tissue specimen in about 2 hours or less.

FIG. 3 is a schematic plan view of a tissue processing system of the invention that may be manually operated in batch or continuous mode.

FIG. 4 shows a shaker bath provided for use in a manually-operated system of the invention.

FIG. 5 shows a conventional microwave oven provided for use in a manually-operated system of the invention.

FIG. 6 shows a paraffin bath provided for use in a manually-operated system of the invention.

FIG. 7 is a schematic illustration of a tissue processing system that is automated, and may be operated in batch or continuous mode.

FIG. 8 is a schematic plan view of a microwave unit of the invention.

FIG. 9 shows electrical and mechanical components of a microwave unit of the invention.

FIG. 10 is a block diagram of the control features of a microwave unit of the invention.

FIG. 11 is a schematic illustration of a tissue processing system with an armature conveyance.

FIG. 12 shows components of an exemplary module without an optionally provided microwave unit.

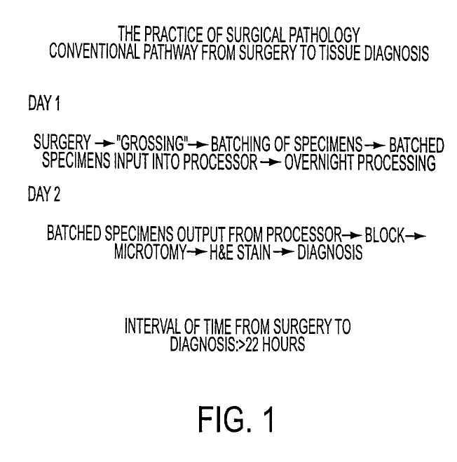

### DETAILED DESCRIPTION OF THE INVENTION

The microwave unit disclosed herein may be used to advantage in conventional tissue processing, but it has been developed in the context of and may be especially adapted for use in the process described in U.S. Appln. No. 60/056,102 and Ser. No. 09/136,292.

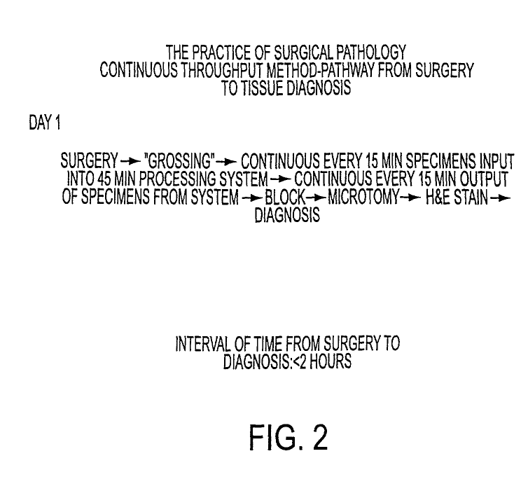

Over 60,000 tissue specimens have been processed using our tissue processing method (see FIG. 2 for an illustrative example). This represents about 30,000 cases per year, and an average of three specimens processed per case. The steps of fixation, dehydration, fat removal, and impregnation can be performed in less than about two hours. This allows a pathologist to evaluate specimens shortly after receipt; perhaps while the patient is still in the operating or recovery room. Patient anxiety can be advantageously reduced by reducing the time required for pathological diagnosis. Rapid and continuous processing is accomplished by decreasing the thickness of tissue specimens, use of non-aqueous solutions composed of admixtures, solution exchange at elevated temperature and with agitation, uniform heating of tissues and solutions with microwave radiation, impregnation under vacuum pressure, or a combination thereof.

With regard to the processing and analysis of solid tissue, a tissue slice must be on the order of 4 to 6 microns to be examined under a microscope, whereas the thinnest slice of fresh tissue that can be obtained by cutting is about 1 mm with the typical slice being on the order of 3 mm. In order to produce a sufficiently thin slice from microscopic examination, it is necessary to harden the tissue so that a finer slice can be obtained (e.g., by sectioning with a microtome). The present invention greatly accelerates the tissue hardening process and thereby turns the conventional overnight processing into a process which totals on the order of about 65 minutes.

Thus, we have developed a simple, safe, low cost, expeditious, and reliable process that permits preparation of impregnated tissue blocks suitable for microtome sectioning in less than two hours from the moment tissue is received in the pathology laboratory. This method allows continuous throughput and flow of specimens, is adaptable to automation, precludes the need for formalin and xylene with their noxious fumes, allows standardization of tissue processing, and requires considerably smaller volumes of reagents than conventional methods. Either fresh or previously fixed tissues can be processed.

In addition to the reduction in time required for tissue processing, the rapid preparation of tissue by the present process is capable of preserving tissue structures and morphology that were lost with conventional methodology. Glycogen is almost always lost using the conventional methodology. This causes lymphatic vessels, particularly of the myometrium, to collapse during conventional processing while they remain widely patent when the present invention is used.

Moreover, studies with tissues processed with the process disclosed herein indicate better preservation of DNA and particularly RNA extraction than with conventional processing methods. Thus, tissues obtained in hospitals and other surgical settings can be processed for both histologic and genetic studies soon after delivery to the laboratory, and archival material may be made available for future research and other applications. Improvements may be expected in the yield of genetic material, the stability of the genetic material in archival form, the size and integrity of the genetic material, and reducing chemical modification of the genetic material in comparison to the prior art.

In the context of the invention, a “tissue specimen” is a piece of tissue that may be processed by the methods disclosed herein. It may also refer to single cells from any biological fluid (e.g., ascites, blood, pleural exudate), or cell suspensions obtained from aspiration of solid organs or lavage of body cavities. Single cells may be pelleted by sedimentation or buoyant centrifugation prior to processing. As shown in the examples, solid pieces (i.e., tissue slices) are commonly processed for histology and pathology.

By “continuous” processing, we mean accessing the system of the invention with additional tissue specimens at intervals determined by the time required to complete an individual step of the process (i.e., a few minutes) instead of the time required to complete the process (i.e., an hour to several hours). At any given time with the invention, there can be tissue specimens at different stages of processing. In other words, there can be continuous throughput and flow of specimens along the various stages of tissue processing with the invention. Continuous processing may be accomplished manually or by an automated instrument.

In one aspect of the process, a tissue specimen is fixed, dehydrated, and fat is removed (i.e., defatted). A suitable admixture for use is a non-aqueous solution comprised of fixative and dehydrating agents, preferably a ketone and an alcohol; the volume ratio of alcohol to ketone may be between about 1:1 to about 3:1. The tissue specimen is incubated for about 25 minutes or less, more preferably for about 15 minutes or less, and even more preferably for about 5 minutes or less. Incubation is preferably between about 30° C. and 65° C., more preferably between about 40° C. and 55° C., and most preferably between about 45° C. and 50° C.

Another aspect of the process is fixation, dehydration, defatting, and clearing of a tissue specimen. A preferred solution in this aspect of the process is alcohol and a clearant. This step of the process may be accomplished in about 5 minutes or less.

In yet another aspect of the process, a tissue specimen is cleared and impregnated in a single solution comprised of a clearant and an impregnating agent. Preferably, this step of the process may be accomplished in about 5 minutes or less. Prior to sectioning, the impregnated tissue specimen may be embedded in the impregnating agent.

A tissue specimen which has been fixed, dehydrated, and defatted may then be impregnated in a wax solution. Consistent with dehydration of the tissue specimen, the wax solution is preferably as low as possible in water content. Thus, the wax solution may be prepared prior to impregnation by heating the wax to evaporate any dissolved water and by degassing under reduced pressure. Impregnation of the tissue specimen may take place under less than atmospheric pressure and at elevated temperature to remove any solvents from the tissue specimen and to draw the wax solution into the tissue specimen.

Vacuum decreases impregnation time by accelerating diffusion and reducing the evaporation temperature of any solvents that may be present in the specimen. The wax solution may comprise degassed paraffin and/or mineral oil. Impregnation of the tissue specimen may be completed in about 15 minutes or less; preferably, completed in about 10 minutes or less. Prior to sectioning, the impregnated tissue specimen may be embedded in the impregnating agent to form a tissue block.

Another embodiment of the process is processing a tissue specimen from fixation to impregnation in a series of solutions, at least some of which are admixtures that perform more than one task at the same time: fixation, dehydration, removal of fat, and impregnation. The admixture may include a fixative, a dehydrating agent, and a fat solvent (e.g., ketone and alcohol). Another solution may include fixative, dehydrating agent, fat solvent, and clearant (e.g., alcohol and xylene). Yet another solution may include a clearant and an impregnating agent (e.g., xylene and paraffin). The tissue specimen may be impregnated in a wax solution comprised of a mixture of different chain lengths (e.g., at room temperature, mineral oil which is liquid and paraffin which is solid).

It should be noted that although many chemicals are multifunctional, preferred admixtures contain more than one chemical. Preferably, an admixture contains at least two or three different chemicals (e.g., alcohol and ketone; alcohol, ketone, and wax). Processing time may be reduced by a non-aqueous admixture (e.g., fixative-dehydrating agent-fat solvent, fixative-dehydrating agent-fat solvent-clearant, clearant-impregnating agent), microwave energy as a source to achieve uniform heating within the tissue specimen, and reducing the pressure by using a vacuum source. Diffusion of the solution into the tissue specimen and chemical exchange may be promoted by mechanical agitation, heat, reduced pressure, or a combination thereof.

The above steps may be accelerated by adding an enhancer, a surfactant, or both to the solutions used in the process. The enhancer may be polyethylene glycol (PEG), mono- and dimethyleneglycol, propylene glycol, polyvinyl pyrrolidone, or the like; the polymer used may be between about 100 and about 500 average molecular weight, preferably about 300 molecular weight. The surfactant may be dimethyl sulfoxide (DMSO), polyoxyethylene sorbitan esters (e.g., TWEEN 80), sodium dimethyl sulfosuccinate, mild household detergents, or the like.

Fixation initiates hardening of the tissue specimen, and may preserve cell morphology by stabilizing proteins and halting cellular degradation. Without chemical fixation, endogenous enzymes will catabolize and lyse the cell, and the tissue micro-anatomy will be altered. The fixative may be a ketone (e.g., acetone, methyl ethyl ketone); aldehyde (e.g., acetylaldehyde, formaldehyde, glutaraldehyde, glyoxal); alcohol (e.g., methanol, ethanol, isopropanol); acetic acid; heavy metals (e.g., lead acetates and citrate, mercuric salts, chromic acid and its salts, picric acid, osmium tetroxide); or the like. Indications that fixation was inadequate can include: disassociation of tissue structures, bubbles in tissue sections, poor and irregular staining, shrunken cells, clumping of cytoplasm, condensation and less distinct nuclear chromatin, and autolysis/hemolysis of erythrocytes. Generally, fixation with acetone is accomplished on a time scale of minutes instead of hours because long exposure turns tissue brittle and causes extreme shrinkage. Further contrasting with conventional fixation using formalin, use of ketones and alcohol is believed to act as fixatives by physically stabilizing proteins (e.g., precipitation) without chemically combining with them.

Dehydration removes water from the tissue specimen to promote hardening. Replacement of water in the tissue specimen with a dehydrating agent also facilitates subsequent replacement of the dehydrating agent with material used for impregnation. This solution exchange is enhanced by using a volatile solvent for dehydration. The dehydrating agent may be low molecular weight alcohols (e.g., methanol, isopropanol, ethanol, propanol, butanol, isobutanol, ethyl butanol, amyl alcohol), ketones, dioxane, alkylene glycols, ethylene glycol, or polyalkylene glycols. Failure to dehydrate the specimen can lead to inadequate impregnation, poor ribbon formation during sectioning, clefts in tissue sections, dissociation of structures, water crystals in tissue sections, and poor staining.

Fat in the tissue specimen is removed with a solvent because fat impairs clearing and impregnation. Inadequate fat removal can result in spreading artifacts of tissue sections, wrinkling of tissue sections, and poor staining. Fat may be removed from the tissue specimen with an organic solvent such as, for example, acetone, chloroform or xylene.

Optionally, the tissue specimen is cleared. The clearant extracts solvents used for dehydrating and/or defatting from the tissue specimen if they are not miscible with the impregnating agent. The tissue may become “clear” and its opacity may be reduced due to this extraction. Examples of clearants include xylene, limonene, benzene, toluene, chloroform, petroleum ether, carbon bisulfide, carbon tetrachloride, dioxane, clove oil, or cedar oil.

Finally, once the tissue specimen is suitably fixed and dehydrated, it is hardened by impregnation with and/or embedded in an agent such as paraffin, mineral oil, non-water-soluble waxes, celloidin, polyalkylene glycols, polyethylene glycols, polyvinyl alcohols, agar, gelatin, nitrocelluloses, methacrylate resins, epoxy resins, or other plastics.

Appropriate hardening of the tissue specimen with adequate preservation of cellular morphology is required prior to placing the impregnated specimen in a block and obtaining ten micron or thinner sections with a microtome knife. Preferred impregnation materials are commercial wax formulae, mixtures of waxes of different melting points (e.g., liquid mineral oil and solid paraffin), paraplast, bioloid, embedol, plastics, and the like. Paraffin has been chosen for use in the examples herein because it is inexpensive, easy to handle, and ribbon sectioning is facilitated by the coherence of structures provided by this material.

This methodology is specially suitable for tissue specimens in which cell-cell contact, tissue organization, organ structure, or a combination thereof must be preserved. With the present invention (e.g., Example 3), such a specimen is a tissue slice preferably less than about 3 mm in its smallest dimension, more preferably about 2 mm or less, even more preferably about 1.5 mm or less, and most preferably about 1 mm or less.

The tissue specimen may be fresh, partially fixed (e.g., fixation in 10% formalin for 2-3 hours), or fixed (e.g., overnight fixation in 10% formalin or any other fixative). The above process allows processing of a tissue specimen from fixation to impregnation in less than about two hours, preferably less than about 90 minutes, more preferably less than about one hour, and even more preferably less than about 45 minutes or 30 minutes. The time required for solution in each step to reach the appropriate temperature is insignificant compared to incubation time for each step, and may be disregarded to calculate the total time for processing. In particular, small biopsies and tissues less than about 1.5 mm thick, as well as those containing little or no fat, could be processed quickly. Tissue may be transported from the operating room to the pathology laboratory in an aqueous solution; such a transport solution may consist of equal volumes of an aqueous buffer and the non-aqueous admixture described herein.

Following impregnation, the tissue specimen can be embedded to produce a block. The agent used to embed the tissue specimen is preferably the same as the material used for impregnation, but a different impregnating agent may also be used. The blocked tissue specimen can be mounted on a microtome to produce tissue sections of between about 1 micron and about 50 microns, preferably between about 2 microns and about 10 microns. The tissue sections may be further processed for histochemical staining, antibody binding, in situ nucleic acid hybridization/amplification, or a combination thereof. The tissue specimens are then typically examined by microscopy, but other techniques for detecting cellular properties may be used to examine the processed tissue specimen (e.g., automated cytometry, autoradiography, electrophoresis of nucleic acid).

Fixation, dehydration, and removal of fat are required for the preparation of tissue prior to impregnation. These steps are facilitated by trimming the tissue to a suitable size prior to processing, and using cassettes which hold such tissue blocks and allow their easy transfer between solutions for fixation, dehydration, removing fat, and impregnation.

If processing of the tissue specimen is incomplete, the sections cut by the microtome knife will appear cracked or “exploded”. Tissue processing is deemed a failure when one or more of the following problems is encountered: embedded tissue blocks are too soft or too hard, sections fall out or show an amount of compression different from the embedding agent, sections appear mushy, tissue ribbons fail to form or are crooked, sections crumble or tear, erythrocytes are lysed, or clumping of cytoplasm, condensation of chromatin, basophilic staining of nucleoli, shrunken cells, spreading artifacts and moth-eaten effect.

For wax-impregnated sections on glass slides made by the present invention, the wax may be melted and removed prior to staining or immunohistochemistry. The tissue section is rehydrated and then analyzed as described below with stains or antibodies. After staining is completed or the histochemical reaction is developed, the slide may be coverslipped and viewed under a microscope. Alternatively, the stained or antibody-decorated specimen may be studied with an instrument for cytometry. The tissue blocks may be stored for archival purposes or retrospective studies.

The present invention is compatible with preparation of nucleic acids, DNA or RNA, from processed tissues. Thus, genetic study is possible for specimens collected routinely in the clinical pathology laboratory. The combined power of these technologies will be great. Histological observations may be correlated with genetics by analyzing one section by staining or immunohistochemistry, and preparing nucleic acids from an adjacent section for genetic analysis. For example, diseased and normal regions of the same section may be compared to detect genetic differences (e.g., mutations, levels of transcription), disease progression may be characterized by comparing genetics differences in samples taken at several time points, and tumor evolution may be assessed by following the accumulation of genetic differences from primary cancer to metastasis.

Mutations may be germline and used to trace genetic predisposition of disease, or mutations may be somatic and used to determine genetic alterations in disease pathogenesis. The disease may be a metabolic or neurologic disorder, malignancy, developmental defect, or caused by an infectious agent. The present invention preserves material for genetic analysis by a simple procedure and room temperature storage.

It is envisioned that the present invention will preserve tissue that yield greater amounts of nucleic acid with a higher average molecular weight than tissues processed by conventional processes.

Many features distinguish the present process from the conventional methodology for tissue processing: (a) thin slicing of the tissues prior to processing; (b) continuous input of tissue specimens, and continuous flow through the system; (c) elimination of water from solutions (i.e., non-aqueous solutions); (d) fixation, dehydration, fat removal, clearing, and impregnation of tissue performed with uniform heating (e.g., microwave energy); (e) admixture solutions to fix-dehydrate-remove fat, fix-dehydrate-remove fat-clear, and clear-impregnate; and (f) impregnation of tissue under reduced pressure with degassed impregnating agent. These features make the present process simple, practical, easily implemented for continuous throughput and flow, and amenable to automation.

Hematoxylin-eosin staining is commonly used for histological study and may be considered a standard for comparison by pathologists. In addition, the present process has been found to be compatible with other stains including trichrome, reticulin, mucicarmine, and elastic stains as described in general references such as Thompson (Selected Histochemical and Histopathological Methods, C. C. Thomas, Springfield, Ill., 1966), Sheehan and Hrapchak (Theory and Practice of Histotechnology, C. V. Mosby, St. Louis, Mo., 1973), and Bancroft and Stevens (Theory and Practice of Histological Techniques, Churchill Livingstone, New York, N.Y., 1982). Such staining procedures would take between 30 minutes and several hours to complete, although rapid staining procedures are available from Fisher Scientific that require only five minutes to accomplish.

Tissue may be obtained from an autopsy, a biopsy (e.g., endoscopic biopsy), or from surgery. For cancer surgery, the ability to provide a pathological diagnosis from a stained tissue section will provide the surgeon with information that may be used prior to the patient's departure from the operating room. For example, an indication from the pathologist that the cancer is confined to the resected tissue may allow the surgeon to be conservative in treatment and to preserve neighboring healthy tissue. Alternatively, a finding by the pathologist that cancer is not confined to a resected organ would permit more aggressive surgical treatment while the patient was still in the operating room.

Over 60,000 samples of tissue have been successfully processed by the present process, including: brain, breast, carcinoma (e.g., bowel, nasopharynx, breast, lung, stomach), cartilage, heart, kidney, liver, lymphoma, meningioma, placenta, prostate, thymus, tonsil, umbilical cord, and uterus. Mineralized tissue (e.g., bone, teeth) would require decalcification prior to processing by the present process. For example, tissue may be decalcified with a hydrochloric acid/ethylenediaminetetraacetic acid (EDTA) solution from Stephens Scientific (Allegiance Healthcare Supply, catalog no. 1209-1A) according to the manufacturer's instructions. Decalcification of large bone fragments may require several hours or even days, but bone marrow biopsies may be decalcified in about 30 minutes to about one hour. Samples from almost every organ of the human body and a large number of diseased tissues have been successfully processed.

Tissue sections processed by the present process may also be used in immunohistochemistry. The present process provides tissue specimens in which antigen is recovered and preserved, the choice of fixative may be optimized for recovery and preservation of particular antigens. Non-specific binding sites are blocked, antigen is bound by specific antibody (i.e., the primary antibody), and non-bound antibody is removed. If labeled with a probe or signal generating moiety, the primary antibody may be detected directly but it is preferred to attach the probe to a protein (e.g., a secondary antibody) that specifically binds the primary antibody. Secondary antibody may be raised against the heavy or light chain constant region of the primary antibody. This amplifies the signal generated by an antigen-antibody conjugate because each primary antibody will bind many secondary antibodies. Alternatively, amplification may occur through other specific interactions such as biotin-streptavidin. Antibody binding is performed in a small volume to reduce usage of expensive reagents and maintain a high binding rate; evaporation of this small volume is reduced by incubation in a humidity chamber. The signal generating moiety is preferably an enzyme which is not otherwise present in the tissue. For example, alkaline phosphatase and horseradish peroxidase may be attached to the secondary antibody or conjugated to streptavidin. Substrates are available for these enzymes that generate a chromogenic, fluorescent, or luminescent product that can be detected visually.

The staining pattern for antigen may be used to localize expression of the antigen in the context of cellular structures revealed by counterstaining. Antigen expression can identify cell or tissue type, developmental stage, tumor prognostic markers, degenerative metabolic processes, or infection by a pathogen.

Antigen-antibody binding may also be visualized with radioactive, fluorescence, or colloidal metal probes by autoradiography, epifluorescent microscopy, or electron microscopy, respectively. Similar probes may be used to detect nucleic acid in the tissue section by in situ hybridization to identify genetic mutations or transcripts; alternatively, the nucleic acid (DNA or RNA) may be extracted from tissue sections and analyzed directly by blotting, or amplified prior to further genetic analysis.

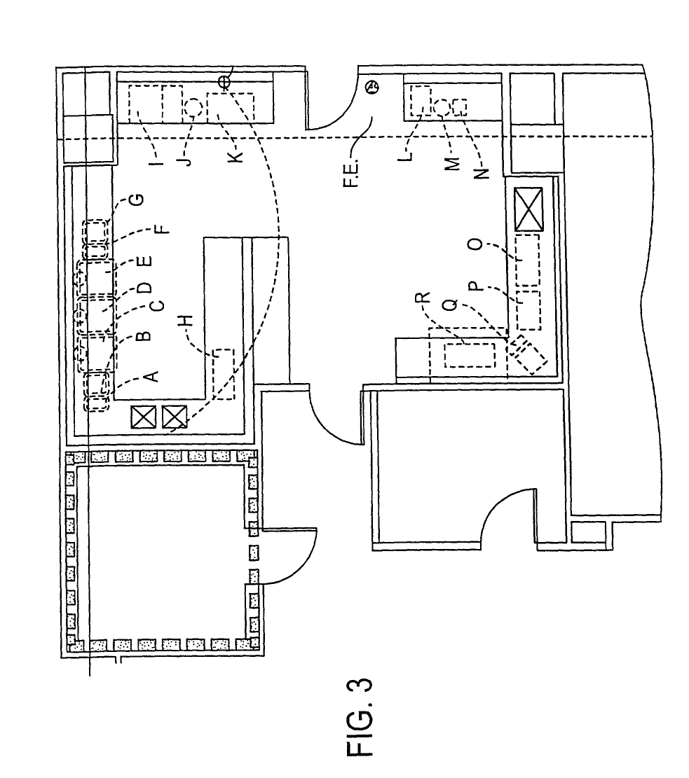

In accordance with an exemplary system for tissue processing provided in accordance with the present invention, a series of tissue processing stations may be provided, e.g., in a single tissue processing unit or area. By way of non-limiting example, a suitable tissue processing facility is illustrated in FIG. 3. Such a facility is suitable for manual operation of the tissue processing system, in either batch or continuous mode.

The first step in the process, which may be carried out at the tissue processing facility or elsewhere, is to prepare a suitable tissue specimen for hardening and ultimate examination. Typically, a slice of the tissue of interest is prepared. The finest slice possible is obtained for processing: about 1 to 3 mm thick, preferably about 1 to 2 mm thick, and more preferably about 1.5 mm thick. Processing time is proportional to the size of the tissue specimen being processed. The tissue slice is placed in a tissue cassette or other holder in which the tissue is contained during subsequent processing until the hardened specimen is ready for sectioning. For ease of handling many cassettes, the cassettes may be placed in a carrier or basket. The cassette or holder is next placed in a first solution provided in accordance with the present invention.

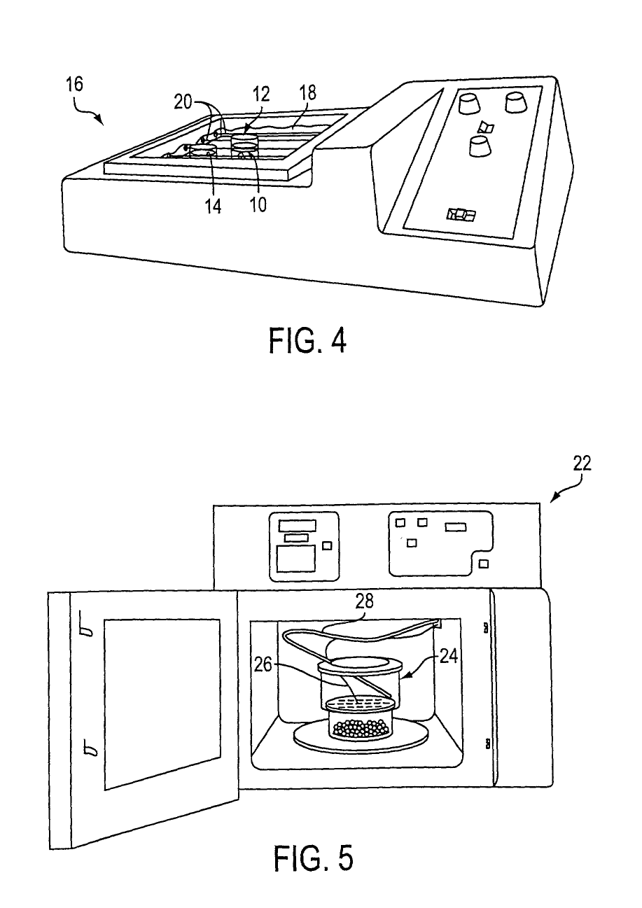

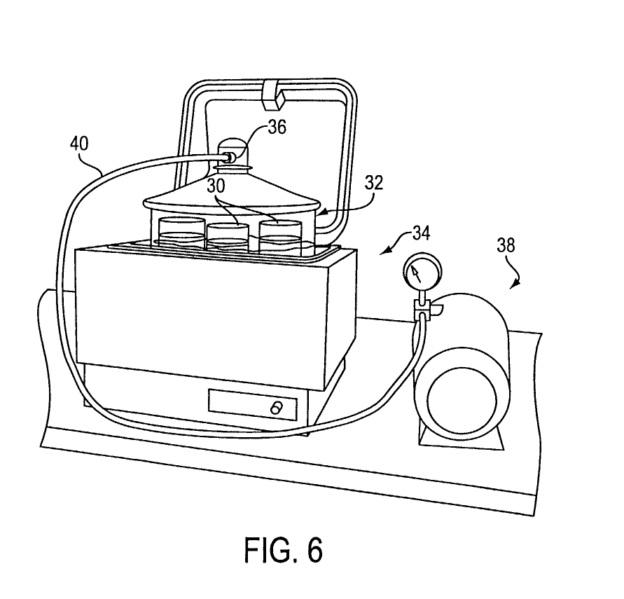

By way of example, the cassette or holder 10 may be placed in a conventional beaker 12, having the first solution 14 therein, preferably by itself as the process described is a substantially continuous one, or together with a limited number of other, similar tissue cassettes or holders. The beaker 12 is then placed in a shaker bath 16, as illustrated in FIG. 4, for gently agitating and heating the same. We have used a LAB-LINE/DUBNOFF incubator-shaker bath (B in FIG. 3) for this purpose. Rather than water, as it is our goal to minimize moisture to which the tissue specimens are exposed and, in fact, ultimately to dehydrate the same, we have provided glycerin as the temperature conducting fluid 18 in the shaker bath 16. Glycerin has the advantage that it is an effective conductor of thermal energy but it does not evaporate. Evaporation would undesirably increase the moisture of the environment in which the tissue is processed, and would require periodic replenishment. Because the glycerin neither needs replacement nor adds moisture to the environment, it is most preferred. For this stage of the process, the tissue specimen (in cassette or holder 10) is disposed in the first solution, in the shaker bath 18 for approximately 3-15 minutes.

Supplemental agitation is desirably also provided during the shaker bath step. Presently, an external pump (A in FIG. 3) is provided with a tube (not shown) therefrom inserted into the solution beaker 12 or other receptacle for bubbling and thus agitating its contents. An aeration diffusion nozzle or plate may be provided to provide for more uniform solution agitation as deemed necessary or desirable.

To ensure that the tissue cassette or holder 10 and first solution containing beakers remain upright and in a desired disposition, we have modified the conventional shaker-bath to provide transverse wires or stays 20, e.g., four wires, defining, e.g., five longitudinal channels in which tissue cassette- or holder-containing beakers 12 may be disposed. Thus, for example, specimen-containing beakers 12 may be regularly added to the shaker bath 18 and sufficiently processed tissue specimens removed in turn therefrom for further processing as described hereinbelow, by adding new specimens on the left end of the shaker bath and removing sufficiently processed specimens from the right end thereof.

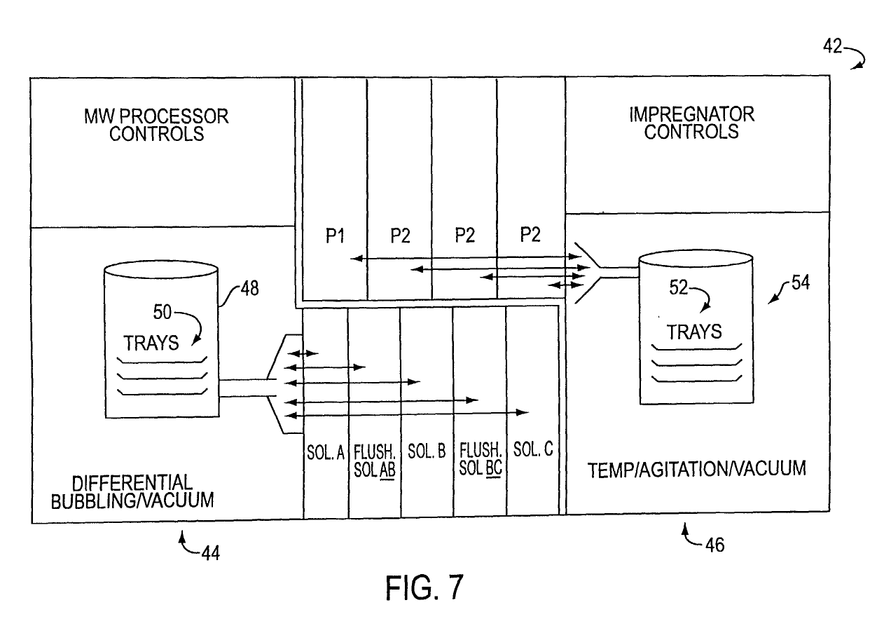

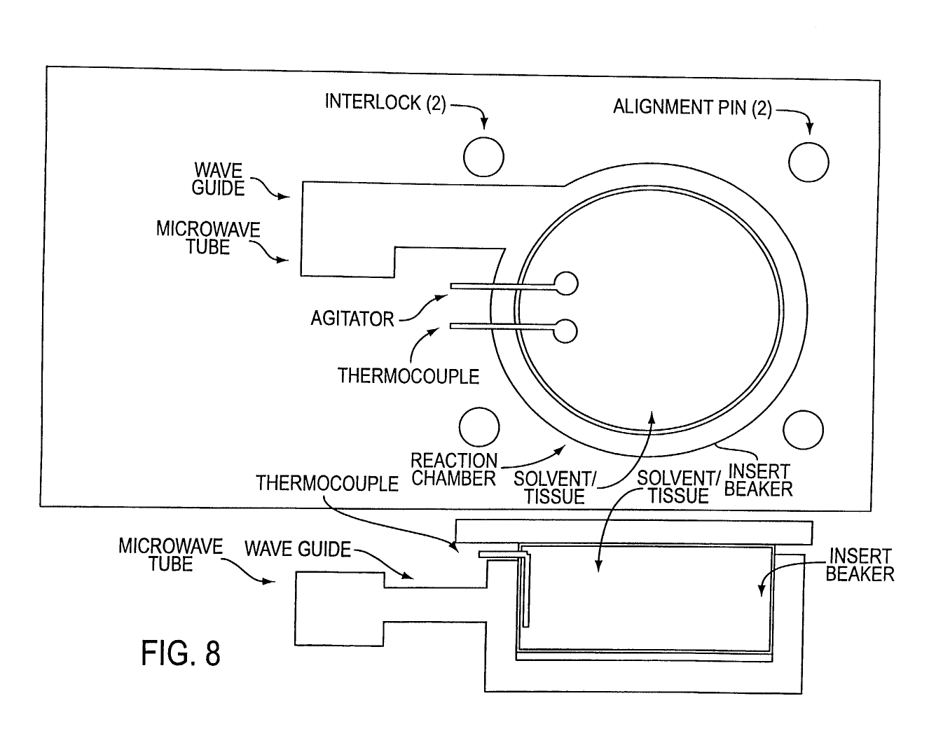

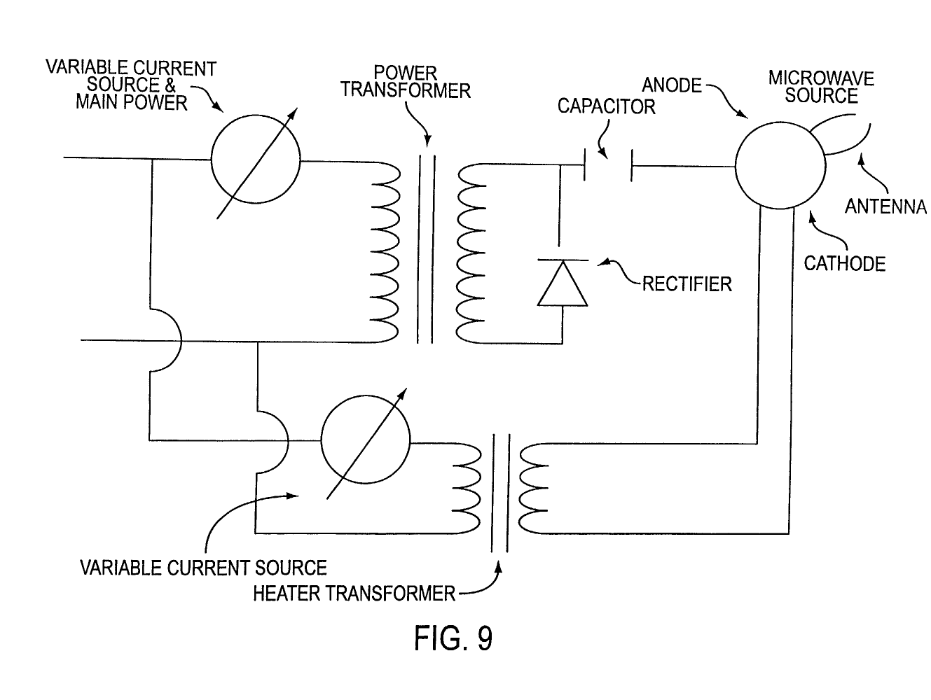

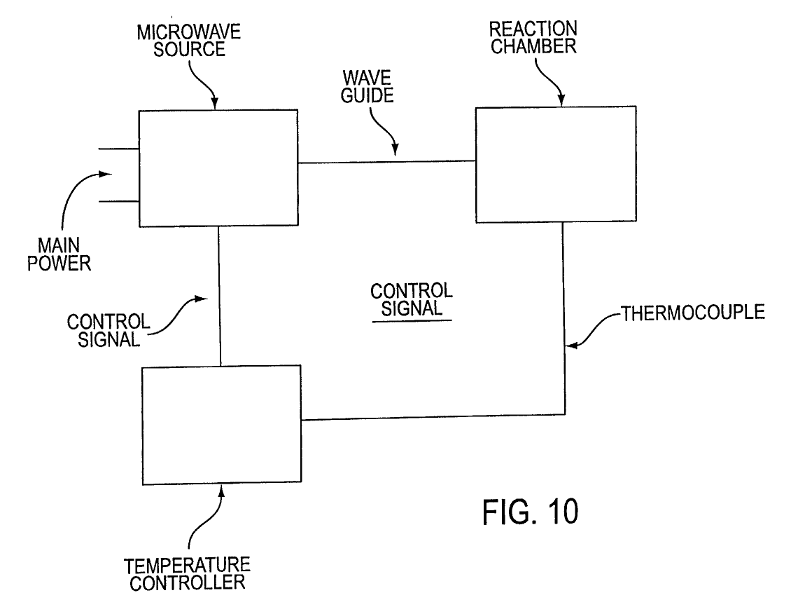

Next, the tissue cassette or holder 10 is exposed to a series of fluids while simultaneously being agitated and subjected to microwave radiation. In one embodiment, three microwave units are provided, as shown at (C, D and E in FIG. 3), each having a different solution in which the tissue cassette or holder is submerged for a prescribed period. In the alternative, a single source of microwave energy could be provided. However, such would require sequential placement of the respective solutions for receiving the tissue cassette or holder. While for a single tissue specimen such solution placement and replacement would not significantly increase the duration of the tissue processing cycle, it can be appreciated that the use of a single microwave that receives multiple solutions, may hinder the continuity of the process with respect to subsequent specimens. Indeed, where a series of microwave units are provided, as a given tissue specimen is moved from one microwave to the next having the next solution, a subsequent tissue specimen can then be received in the first microwave unit. Thus, providing a unit for each of the respective solutions means that a subsequent tissue specimen need not be held while all microwave processing steps of the proceeding specimen have been completed. It is to be understood, however, that with the noted hindrance of continuity, the three microwave units illustrated could be reduced to two or even one. Likewise, other steps in the process may be combined or sub-combined as deemed necessary or desirable from a balance of process continuity versus a potential reduction in manpower, equipment, space requirements, etc. An exemplary such more compact unit is discussed in greater detail below, with reference to FIG. 7.

With reference now to FIG. 5, an exemplary microwave unit 22 for tissue processing is illustrated. For applying microwave radiation, we are currently using laboratory microwave ovens obtained from Energy Beam Sciences, Inc. We have used two microwave processor models, H-2800 and H-2500. Either model or another, similar such system could be used. By way of example, a Pyrex beaker or other clear microwaveable fluid receptacle 24 is utilized to hold respectively second, third and fourth solutions provided in accordance with the process in each of the three microwave units (FIG. 3). A temperature probe 26 is placed in the solution to ensure that the temperature of the respective bath is within the desired range. Moreover, to provide for agitation, which accelerates the tissue processing, aeration is provided. The microwave units we have used include a tube 28 for aeration. A single tube may be inserted into the bath, but for more uniform and complete agitation, it is most preferred to provide a diffusion plate or nozzle head (not shown in detail) in cooperation with the gas tube 28 for diffusing the agitating bubbles, e.g., across a substantial portion of the diameter of the solution receptacle for uniform agitation of the entire volume of solution. Such diffusion plates and nozzles are well known and can be provided, e.g., at the base of the solution receptacle.

Conventionally, paraffin is degassed as a part of the tissue processing procedure. Degassing removes organic solvents from the paraffin. To enhance this process and to reuse the paraffin in the system, we propose continuous degassing. This is accomplished by maintaining the vacuum within the covered Pyrex dessicator jar 32 at 640 mm Hg.

Following the three sequential steps employing microwave radiation, the tissue cassette(s) or holder(s) are placed in a paraffin bath (J in FIG. 3). Currently, we provide a paraffin bath comprising three paraffin bath stations (beakers) 30 provided within a covered jar 32. For the purpose of temperature control, the jar 32 is placed in, e.g., a Poly Science brand water bath 34 at (G in FIG. 3). By applying a grease or the like to the internal edges of the flanges on both the lid and jar, an airtight coupling can be provided between the lid and jar and thus a vacuum can be pulled through a tooled hose connector 36 provided in the lid. Suitable such covered jars are available from Fisher Scientific (model 01-092-25). To create a vacuum within the covered jar 32, a conventional pressure/vacuum pump 38 (F in FIG. 3) is coupled to a tube 40 that is in turn coupled to connector 36. A suitable such power operated pump is available from Fisher Scientific and has for example a 100 psi max. Agitation is preferably provided during the paraffin bath step, either through vibratory agitation, ultrasound, or potentially via aeration.

Next the tissue specimen must be embedded. For that purpose we use a conventional TISSUE-TEK embedding console system (I in FIG. 3) available from Miles-Sakura, e.g., Model No. 4708.

The embedded tissue specimen is then cut in a conventional manner with a microtome (L in FIG. 3) and floated (M in FIG. 3) for placement, we use the Leitz 1512 microtome, and the Lipshaw electric tissue float Model 375. A hot plate is provided (N in FIG. 3).

After the slice is disposed on the slide, the slide is heated to remove the paraffin.

We have used the Isotemp Oven 300 series available from Fisher (K in FIG. 3).

Next the slides are stained. To accelerate the staining process, we propose to use an automated stainer (O in FIG. 3) to reduce the number of personnel and time required. A non-continuous process could use the Miles-Sakura diversified stainer DRS-601 which stains slides in batches; alternatively, a continuous process could use a Leica auto stainer XL which contains a dewaxing stage so that separate incubation in an oven may be omitted. An immunohistochemical (IHC) stainer (P in FIG. 3) and IHC controls (Q in FIG. 3) are also shown The fixed and stained tissue specimen is then covered, e.g. with the TISSUE-TEK coverslipper, Model No. 4764 (R in FIG. 3).

As described above, the system for carrying out the dehydration and impregnation in accordance with the present process can be a series of discrete units. In the alternative, as also noted above, one or more steps can be carried out in a single processing component or unit. As also discussed above, the number of units provided and the steps carried out by each unit impacts the continuity of the processing unit. Thus, in low volume environments, a single unit for carrying out a plurality of the tissue processing steps may be advantageous and will not significantly impact continuity of tissue processing. In higher volume systems environments, two or more units may be preferred.

An exemplary combined unit 42 is illustrated in FIG. 7. The combined unit in fact includes two subunits; a microwave processor unit 44 and an impregnator unit 46. The microwave processor unit 44 is provided for sequentially submerging the tissue being processed in solution A, solution B, and solution C, in each instance agitating the solution and exposing the tissue to microwave energy. Thus, in the illustrated embodiment, vessel 48 is provided for receiving, e.g., one or more tray carriers 50 on which one or more tissue cassettes 10 may be placed. The vessel 48 is fluidly coupled to a source of each of the solutions for tissue dehydration. Thus, once the tissue cassette(s) are placed on the respective tray carrier(s) 50, solution A is conducted to the vessel 48 and microwave energy is applied thereto simultaneous to agitation via, for example, an aeration tube (not shown in FIG. 7). After a sufficient time of exposure has passed, solution A is drained and the tissue cassettes are preferably flushed either with solution B or with a combination of solution A and solution B so as to substantially eliminate residual solution A. Solution B is then fed to the vessel 48, whereupon microwave energy and agitation are again applied for a prescribed period. At the conclusion of administration of solution B, solution B is returned to a storage vessel therefor and the tissue specimens are flushed either with solution C or a combination of solution B and solution C. Thereafter, solution C is fed to the vessel 48, agitation and microwave energy are applied, and ultimately solution C is drained. The tissue specimens are then ready for impregnation.

In the illustrated embodiment impregnation is carried out in a second subunit 46 of the assembly. This allows impregnation to be carried out while a subsequent tissue specimen(s) are subject to microwave energy application. If a single unit is provided, then the vessel used for microwave processing can be used for impregnation however the microwave energy would not be applied thereto during the impregnation steps.

In accordance with the proposed impregnation process, a series of paraffin solutions, e.g., 3 or 4, are applied to the tissue cassettes disposed e.g. on suitable tray carriers in a vessel 54, to provide sequential paraffin baths to effect the impregnation of the tissue specimen as a final step in the tissue preparation process. In the impregnator subunit 46, the tissue specimens are placed under a vacuum at a controlled elevated temperature. The tissue specimens are preferably also agitated during this step with a magnetic stirrer, ultrasound, or air bubbler.

Here, the tray carrier may be transferred between vessels manually or by a track conveyance (not shown in FIG. 7). Movement of the tissue specimens can be minimized by filling the vessel containing a stationary carrier with different solutions and then draining the vessel between changes of solution. The remaining embedding, etc. steps of slide preparation are carried as outlined above with reference to FIG. 3.

The microwave unit provides gentle heating of a tissue specimen while preventing its over cooking, and uniform heating in the reaction chamber which to ensure specimens at different locations in the chamber are maintained at about the same temperature. Over cooking is defined as a change in the histologic structure of the tissue specimen because the microwave field is too intense. Microwaves can heat the tissue specimen better than the surrounding solution; this effect is minimized by allowing sufficient time for the heat to be dissipated from the tissue specimen into the surroundings.

A microwave unit of the invention is comprised of: (a) a source of microwave energy (e.g., magnetron, klystron, traveling wave tube); (b) a waveguide that transmits the microwave energy from the source to a reaction chamber, its dimensions and shape being adapted for this purpose; and (c) a reaction chamber that receives the transmitted microwave energy and is adapted to process a tissue specimen by at least chemical fixation, dehydration, and defatting. The reaction chamber may contain a plurality of different tissue specimens. Preferably, the interior geometry of the reaction chamber is configured to achieve uniform distribution of microwave energy and heating of its contents. Similarly, the source and the waveguide are configured to achieve minimal energy loss during transmission of the microwave radiation.

Heating may be controlled by cycling power on-off in cycles of 10-25 seconds because a minimum time is required by the heating characteristics of the cathode of the microwave source. But this may cause over cooking of the tissue, so it is preferred that heating be controlled through a variable current source to allow continuous variation in the power delivered by the microwave source.

The microwave unit may be further comprised of any combination of a removable container adapted to fit in the reaction chamber and to receive at least one tissue specimen (e.g., a basket); at least one temperature and/or pressure probe to monitor conditions in the reaction chamber; one or more energy probes to monitor microwave energy being sent by the source, transmitted through the waveguide, and/or received by the reaction chamber; a closure adapted to fit the reaction chamber and to isolate the reaction chamber from the operator's surroundings; thermal insulation to retain heat in the reaction chamber; shielding to isolate electronic components from chemicals in the reaction chamber; and control circuitry to receive input from at least one probe or timer, and to regulate at least one of the microwave energy from the source, transmitted through the waveguide, and/or received in the reaction chamber.

Characteristics of the materials used for the seal are the ability to hermetically isolate the reaction chamber from the atmosphere, substantial transparency to microwave radiation, malleability to ensure a tight fit which conforms to the closure, and chemical resistance to the solutions in the process. Modification of the reaction chamber with (a) closure and hermetic seal to reduce evaporation and (b) thermal insulation can reduce the power required to operate the microwave unit by two- or three-fold.

The tissue processing system may utilize the microwave unit as at least one module of the system. Such system may be manually operated or automated. Tissue specimens may be loaded into the system and processed either continuously or batchwise; continuous processing is preferred. The system may be adapted for use in the process described above or in other histochemical reactions.

The system for tissue processing of the invention comprises a physically linked series of modules (e.g., reaction chambers with or without an operably linked microwave unit) to accomplish a combination of fixation, dehydration, defatting, clearing, and impregnation of a tissue specimen. The system may be comprised of one module or a plurality of them. Each module would constitute a part of the entire processing cycle, but an individual module may accomplish more than one of the listed steps (i.e., fixation, dehydration, defatting, clearing, and impregnation) of tissue processing because of the chemical composition contained therein. A recorder may be included to receive measurements of reaction conditions in at least one module and other performance characteristics of the system (e.g., amount of chemical in a module, time spent by a tissue specimen within a module or in contact with a chemical), and to store the measurements for retrieval by the operator.

For batch processing, the modules may occupy the same space and/or the tissue specimen may remain stationary. Microwave or thermal energy may be regulated and transmitted into the same space, or onto the stationary tissue specimen at different times in the process. Chemical solutions and/or vapors may be moved into or out of the same space, or brought into or out of contact with the stationary tissue specimen. It would be preferred to minimize space requirements for the system by using a single reaction chamber and transporting the different chemical compositions into the reaction chamber by tubing or flexible piping from separate storage tanks. A controller can receive input from the reaction chamber and/or from timing that part of the processing cycle, and thereby regulate the transport of the different chemical compositions.

For continuous processing, it is preferred to have a plurality of modules containing at least four, five, or six different chemical compositions and to have at least one armature or track conveyance to move the tissue specimens among the modules. The system will preferably be comprised of at least one, two, or three microwave units. In preferred embodiments of the invention, if a tissue specimen is transferred from one chemical composition to another with the same chemical composition, it may be possible to combine these parts of the processing cycle into the same module with an exchange of the chemical composition therein. Thus, certain parts of the processing cycle may be combined and the number of different modules that are required could be reduced. Plumbing may be simplified as compared to a batch processing because, in many of the envisioned embodiments, the chemical composition may remain in the reaction chamber during the entire processing cycle and be moved into the reaction chamber only at the initiation of the cycle in a filling step, or out of the reaction chamber at the termination of the cycle in a emptying step. Controller circuitry may also be simplified if movement between modules occurs in an integral multiple of a common block of time. It is preferred that the number of different modules, some of which may contain identical chemical compositions, be at least any integer from four to ten.

In accordance with the invention, variations on the above embodiments are envisioned. Various configurations of the tissue processing system are possible, and optional modules may be connected to form a portion of the system. The specific configuration chosen may be dictated by the average number of specimens that will be processed on a daily basis by the clinical laboratory, and/or the speed with which histology or pathology reports must be prepared.

The system may incorporate a conventional microwave oven, the improved microwave unit of the invention, or any combination thereof.

The system may be manually operated or automated. Manual operation is particularly suited for research and development because variations in the process or apparatus may be quickly assessed. For automated instruments, tissue specimens may be transported by armature or track conveyance and/or chemical compositions may be transferred by corrosion-resistant plumbing. Thus, tissue processing may be automated by moving tissue specimens between stationary modules in a particular sequence for set times, filling and emptying modules of different chemicals such that stationary tissue specimens are incubated in a particular sequence for set times, or a combination thereof.

The armature conveyance may, for example, grab the specimen with a pincer-like mechanism or catch the specimen with a hook-like device. The arm may be articulated to perform human-like motion; or may be mounted in a fixed coordinate rack with linear or two dimensional movement, and optionally another dimension of movement provided by varying the height of the arm over the system. The track conveyance may be made from resilient or tacky material to fix the specimen on the track by friction, or there may be a regular series of bumps or walls to trap the specimen therebetween. The track may be formed as a continuous belt or may be a series of belts that convey the tissue specimen, with the belt put into motion with a roller or sprocket mechanism. The cassette or holder may be adapted for conveyance by having a stem (with or without a knob) to be grabbed or a loop to be caught by the arm, or by fitting within a groove or indentation in the track. Similarly, the cassette or holder may be organized in a carrier or basket for processing a large number of specimens, the carrier or basket being adapted for transport by the armature or track conveyance.

Electric motors and controllers may be used to transport a tissue specimen by the operator's real-time command or selection of a stored program. A simple mechanism of controlling the time spent by the tissue specimen in each module would be to move the tissue sample or holder thereof at a constant speed and to adjust the length of the path through each module to accommodate the intended incubation time.

The piping or flexible tubing, as well as other components of the plumbing, should resist corrosion by the chemicals used in tissue processing (e.g., polyethylene, polyvinyl chloride, Teflon, stainless steel). Mechanical or electric pumps/valves and controllers may be used to move chemical compositions in any combination from storage tank to reaction chamber, from reaction chamber to storage tank if the composition can be reused, from reaction chamber to waste tank if the composition is to be flushed from the system, to fill the storage tank, and to flush the waste tank by the operator's real-time command or selection of a stored program. Heating a combination of plumbing components may be necessary to maintain the chemical composition at reaction temperature or to ensure that the chemical composition (e.g., paraffin-containing) is kept in a transportable fluid state. In contrast, vapor seals and/or cooling may be necessary to isolate corrosive vapors from the mechanical and electrical components of the system.

Specimens may be processed continuously or batchwise.

Safety considerations and precautions for an automated instrument (e.g., alarm monitor, proximity sensor) can be incorporated into the system.

Furthermore the accessories, disposable parts (e.g., cassettes, mesh bags), and reagents that have been adapted for use in the system may also be considered as a part of the system. These specially designed instruments and apparatuses have also been described in U.S. Appln. No. 60/056,102 and Ser. No. 09/136,292.

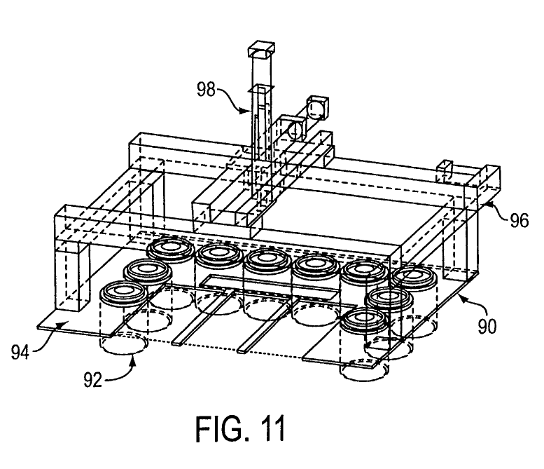

Another exemplary combined unit 90 is illustrated in FIG. 11. Ten vessels 92 are mounted on the top surface 94. The three microwave units in the front and the six vessels in the back contain the solutions described for each of the nine stations in Example 3; the remaining four vessels, two one each side, are entrance and holding stations. Only a portion of each vessel is visible above the top surface.

A gantry 96 above the top surface of the instrument allows movement of the armature 98 in an x-y plane above and parallel to the top surface 94 of the combined unit 90. The armature 98 travels in the vertical direction to open and close each vessel 92, and to move tissue specimens among the vessels containing tissue processing solutions. A stepper motor with ball screw in each axis moves the arm in the vertical direction.

Five baskets containing cassettes may be processed at the same time (e.g., continuously) with each basket being located at a different station. Up to about 40 cassettes may be placed in each basket. The rate of processing is as described for Example 3 and the total time for completion is about 65 min. Baskets awaiting processing or those already processed are placed at entrance or holding stations, respectively. Lids may be placed at one of the entrance stations. Each of the lids for stations with microwave units is provided with its own holding place. The robot arm locates objects and stations by their fixed positions in the system.

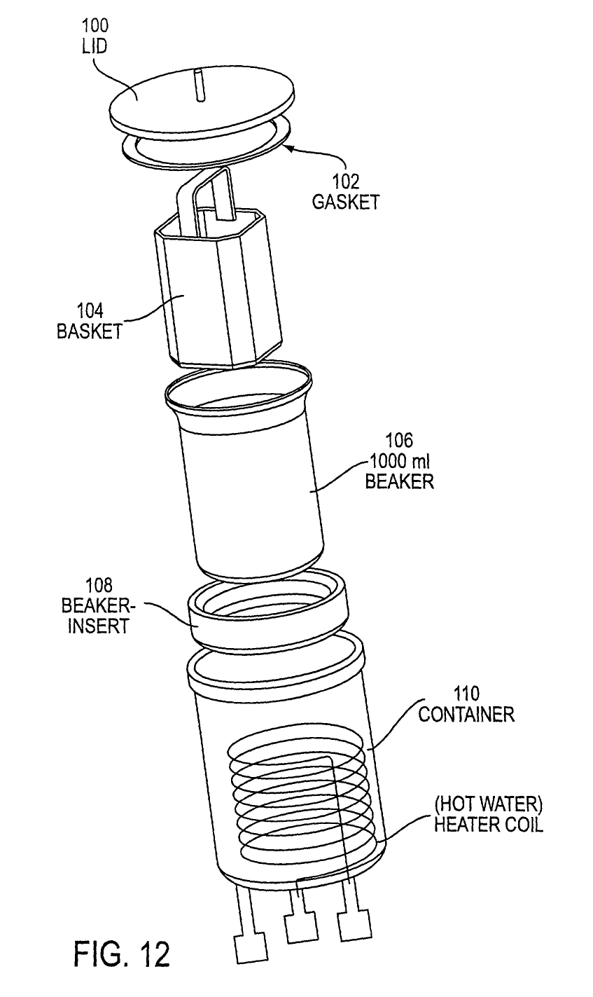

An exemplary vessel 92 of the combined unit 90 is illustrated in FIG. 12 without showing a microwave unit which may be optionally provided to heat the vessel. A lid 100 and gasket 102 covers the vessel 92 and must be displaced by the armature 98 before the basket 104 is grabbed. Instead of transferring different chemical solutions into and out of the vessel 92, the basket 104 is transferred among different vessels 92. Holding the basket 104 above a 1000 ml Pyrex beaker 106 for about 10 sec allows excess chemical solution to drain back into the vessel 92 before the basket 104 is transferred. Each chemical solution is contained in a predetermined beaker 106. Thus, the sequence in which the basket 104 is transferred among vessels 92, each containing a particular composition of tissue processing chemicals, and the time the basket 104 is incubated in each vessel 92 will dictate the series of chemical reactions necessary to accomplish the process according to the present invention. The beaker 106 can be removed from the combined unit 90; such removal facilitates manual replacement of the chemical solution in the beaker 106. A Delrin insert 108 provides thermal insulation during incubation of the tissue specimens and the beaker 110 is fixed on the flat surface 94 of the combined unit 90 to receive the other components of the vessel 92.

The controller can direct the armature 98 to lift the lid 100 and to store it. The gasket 102 can be attached to the lid and moved with it. This process of removing the lid and gasket is performed for both the vessel which initially contains the tissue specimens and the vessel into which the tissue specimens will be subsequently transferred. The armature 98 then removes the basket 104 from the beaker 106, allows solution to drain from the basket and any cassettes which may be contained therein back into the beaker for about 10 sec, and transfers the basket to the beaker containing the next chemical solution in the process. Finally, the lids and gaskets are replaced on each beaker. The total time for such a transfer is about 1 min. During transfer, the temperature within the open beaker 106 is maintained within about 2° C.

Stations containing impregnation agent (e.g., mineral oil, paraffin) may be heated using a common heating source. A heating element maintains the temperature of water to keep the impregnation agent as a molten solution. The hot water circulates to each station for which it is needed; each station is attached to a supply and return manifold. Heating at a station is maintained by a coil of tubing located inside the chamber of the station; this heating coil transfer heat to the solution within the chamber.

The present invention will have many advantages over conventional methods in the areas of the practice of pathology, patient care, biomedical research, and education.

The availability of microscopic diagnosis of tissue specimens within about 40 minutes to about two hours after receipt will allow rapid, or even real-time, clinical interaction between surgical intervention and pathological evaluation. For example, if 65 minutes is taken to process tissue, a stat diagnosis may be given in about two hours. This may bring about significant improvements in patient care by eliminating or reducing to a minimum patient anxiety during the wait for diagnosis of disease, prognosis, and planning for treatment.

Consequently, there will be a drastic reordering of the workflow in pathology laboratories. Clinical laboratory space, pathological expertise, and clerical and technical personnel will be utilized more efficiently. Continuous workflow will improve accessibility and responsiveness of pathologists who process and evaluate specimens, reduce the number of pathologists needed to process and evaluate specimens, and may also improve medical education, particularly the accessibility and responsiveness of residency programs.

The smaller volume of reagents will also result in cost savings. Elimination of formaldehyde and xylene, and the diminished requirement for other hazardous chemicals, will provide benefits to the environment and increased safety in the laboratory. The costs involved in handling and disposal of hazardous chemicals will be reduced.

Standardization of tissue fixation and processing procedures will ease comparison of specimens from different laboratories. Artifacts in histology due to the use of formaldehyde and/or prolonged processing will be eliminated; thus, allowing more precise evaluation of microscopic morphology of normal and diseased tissues. Similarly, antigen retrieval and staining will be improved. For genetic analysis, formaldehyde-induced DNA mutations will be eliminated and extraction of nucleic acid from archival material may be enhanced. The feasibility of RNA studies from stored, fixed paraffin-embedded tissue opens unlimited avenues for diagnostic and research applications.

All books, articles, applications, and patents cited in this specification are incorporated herein by reference in their entirety.

The following examples are meant to be illustrative of the present invention; however, the practice of the invention is not limited or restricted in any way by them. N.B. Energy Beam Sciences' tissue microwave processors are examples of conventional microwave ovens that are available for commercial use.

### EXAMPLES

### Example 1

Thick tissues were sliced to a maximum of 2 mm, preferably 1.5 mm or less. Two mm thick or thinner slices, or small biopsies of fresh or previously fixed tissue were held in tissue cassettes and placed in a non-aqueous first solution of:

40% isopropyl alcohol,

40% acetone,

20% polyethylene glycol (average molecular weight 300), and

1% dimethyl sulfoxide (DMSO) (i.e., 10 ml per liter of the above mixture).

Tissues specimens were incubated for 15 min at a glycerin bath temperature between 45° C. and 50° C. The 400 ml solution for fixation was placed in a 500 ml beaker in a water bath shaker (linear displacement of 5 cm/sec). Additional agitation of the fixation solution was provided by bubbling with an air pump.

Fixation, dehydration, fat removal, clearing, and impregnation are accomplished by sequential exposure of the tissue specimen to three different solutions (i.e., the second, third, and fourth solutions described below), one in each of three microwave ovens from Energy Beam Sciences. A one liter solution of 70% isopropyl alcohol and 30% polyethylene glycol (average molecular weight 300) is placed in the first oven (model H2800) in a 1500 ml beaker, the solution in the second oven (model H2800) consists of one liter of 70% isopropyl alcohol and 30% xylene in a 1500 ml beaker, and the third oven (model H2500) contains a solution of 1000 ml of xylene and 300 gm of paraffin in a 1500 ml beaker. Ten ml of DMSO per liter are added to these three solutions. Heating at 60° C. by microwave radiation is effected for 15 minutes in the first oven, and 5 minutes each in the second and third ovens (75% power setting with a cycle of 2 seconds).

To continue paraffin impregnation after completion of the microwave radiation steps, tissue sections were incubated in four 500 ml baths of molten paraffin placed within a large dessicator filled with paraffin, and resting in a glycerin bath at 75° C. Tissue sections were transferred from one paraffin bath to the next at 3 minute intervals, for a total impregnation time of 12 minutes. Each 3 minute interval was measured from the time that the pressure reading is about 640 mm of Hg. No agitation was used in this step.

### Example 2

Fixation, dehydration, fat removal, and paraffin impregnation of fresh or fixed tissue sections, approximately 1 mm thick, was accomplished in 40 minutes by exposing these tissue sections to four successive steps as follows.

Step 1.

In this example, the first solution consisted of:

60% isopropyl alcohol,

10% acetone,

30% polyethylene glycol (average molecular weight 300), and

dimethyl sulfoxide (DMSO) added at an approximate concentration of 1% of the total volume. One liter of this solution suffices to fix 60 specimens of tissue held in tissue cassettes. The specimens were incubated at 55° C. in a commercial tissue microwave processor (H2500 or H2800, Energy Beam Sciences) for 5 min each in a series of three baths containing the first solution (15 min total incubation); agitation of the solution was obtained by bubbling to accelerate solution exchange.

Step 2.

The specimens were incubated in a solution of 70% isopropyl alcohol, 30% acetone, and DMSO added at an approximate concentration of 1% at 60° C. Specimens were heated in a commercial tissue microwave processor (H2800, Energy Beam Sciences) for 5 min each in two beakers containing the solution (10 min total incubation), which were agitated by bubbling.

Step 3.

Following microwave irradiation, impregnation was initiated by incubation in a wax solution of 25% mineral oil and 75% molten paraffin placed in a large dessicator resting in a 60° C. or 70° C. glycerin bath, under a vacuum of about 200 mm of Hg, for 5 min. Paraffin was degassed prior to use as described in Example 1.

Step 4.

Impregnation was completed by incubation in four baths of molten paraffin placed within a large dessicator resting in a glycerin bath at 75° C. Tissue sections were transferred from one paraffin bath to the next at 3 min intervals, for a total impregnation time of 12 min. Each 3 min interval was measured for the time that the pressure reading is about 640 mm of Hg.

In this example, 6 ml of a color indicator stock solution (10 gm methylene blue in 1000 ml of isopropyl alcohol) was added to each of the solutions of isopropyl alcohol and acetone. Tissue specimens acquire a blue tint that facilitates their handling during impregnation and handling; penetration of the tissue specimen may also be monitored by observation of an even blue color throughout the tissue specimen.

### Example 3

Fixation, dehydration, fat removal, and paraffin impregnation of fresh or fixed tissue sections, up to about 1 to 2 mm thick, were accomplished in about 65 minutes as follows. Sections of 1.5 mm or less are preferred for consistency.

Step 1.

In this example, the first solution consists of:

40% isopropyl alcohol,

40% acetone,

20% polyethylene glycol (average molecular weight 300),

glacial acetic acid added at an approximate concentration of 0.5% of the total volume, and

dimethyl sulfoxide (DMSO) added at an approximate concentration of 1% of the total volume. One liter of this solution suffices to fix 60 specimens of tissue held in tissue cassettes. The specimens are incubated at 65° C. in a commercial tissue microwave processor (H2500 or H2800, Energy Beam Sciences) for 15 min in a 1500 ml beaker containing the first solution; agitation of the solution is obtained by bubbling to accelerate solution exchange.

Step 2.

The specimens are incubated in a solution of 55% isopropyl alcohol, 25% acetone, 10% polyethylene glycol (average molecular weight 300), 10% low viscosity mineral oil, glacial acetic acid added at an approximate concentration of 0.5% of the total volume, and DMSO added at an approximate concentration of 1%. Specimens are heated at 65° C. in a commercial tissue microwave processor (H2800, Energy Beam Sciences) for 15 min in a 1500 ml beaker containing the solution, which is agitated by bubbling.

Step 3.

The specimens are incubated in a solution of 55% isopropyl alcohol, 25% acetone, 20% low viscosity mineral oil, glacial acetic acid added at an approximate concentration of 0.5% of the total volume, and DMSO added at an approximate concentration of 1% of the total volume. Specimens are heated at 65° C. in a commercial tissue microwave processor (H2800, Energy Beam Sciences) for 5 minutes in a 1500 ml beaker containing the solution, which is agitated by bubbling.

Step 4.

Following microwave irradiation, impregnation is initiated by incubation in two baths of a wax solution of 30% low viscosity mineral oil and 70% molten paraffin placed in a large dessicator resting in a 60° C. glycerin bath, under a vacuum of about 640 mm of Hg, for 5 min. in each bath.

Step 5.

Impregnation is completed by incubation in four baths of molten paraffin placed within a large dessicator resting in a glycerin bath at about 75° C. to 80° C. and a reduced pressure of about 640 mm of Hg, for 5 min each. Tissue specimens were transferred from one paraffin bath to the next at 5 min intervals, for a total impregnation time of 20 min. Each 5 min interval was measured for the time that the pressure reading is about 640 mm of Hg.

### Example 4

Using the illustrated robotic system, the nine steps of Example 3 are performed using those solutions. Following completion of the first step, the robotic arm removes the lid from station 1 at a time determined by the length of incubation (e.g., 15 min if one microwave station is used and 5 min if three microwave stations are used) and places it in its holding place. The robotic arm then removes the lid from station 2 and places it in its holding place. A basket containing tissue cassettes will be removed from station 1 by the robotic arm, held for a few seconds to drain, and then moved to station 2. The robotic arm replaces the lids on stations 1 and 2. For transfer to subsequent stations, this procedure is repeated.

There is an entrance station where the basket is placed, and from which the robotic arm transfers the basket to station 1 to initiate tissue processing. Following completion of step 5 (e.g., station 14 in a preferred configuration), the robotic arm places the basket into a holding station of molten paraffin.

### Example 5

### Detection of Antigen in Tissue Sections

Paraffin sections are cut on a microtome to a thickness of 3 microns, placed in a water bath, and floated onto a glass slide. Paraffin was melted by placing slides in either a 58° C. oven for 30 minutes, or preferably in a 37° C. oven for approximately 18 hours or overnight, and then dewaxed in a xylene bath for 10 minutes. Slides were rehydrated in decreasing ethanol solutions for 1 min each (two baths of absolute, two baths of 95%, and one bath of 90%) and rinsed by submerging in tap water for 2 min.

Endogenous peroxidase was blocked with a solution of 6% hydrogen peroxide (H2O₂) and methanol, or 35 ml of 6% H₂O₂ with 140 ml methanol, incubated for 15 min. Slides were rinsed by submerging in tap water for 2 min and PBS for 2 min, then dried.

Slides were transferred to a humidity chamber and normal horse serum (NHS) was added to block for 10 min. Excess normal horse serum was decanted from slides, and specific primary antibody was incubated for 30 min on the tissue section in a humidity chamber at room temperature. Slides were flushed with PBS with back and forth motion using a squeeze bottle, submerged in a PBS bath for 2 min, and excess PBS was dried off each slide. Linking solution (also known as secondary antibody or biotinylated anti-rabbit or anti-mouse) was added to each tissue section and incubated for 25 min in a humidity chamber at room temperature. Such rabbit, rat, and mouse secondary antibodies (e.g., anti-IgM, anti-IgG) were obtained from Dako (Carpinteria, Calif.) and used at a dilution of about 1:600. Slides were flushed with PBS using a squeeze bottle, submerged in a PBS bath for 2 min, and excess PBS was dried off each slide.

Signal was developed according to the manufacturer's instructions (Vector Laboratories). Avidin-biotin complex (ABC) solution was added to the tissue section and incubated for 25 min in humidity chamber. Slides were flushed with PBS in a squeeze bottle and submerged in a rack in a PBS bath for 2 min. The rack was submerged in a bath of diaminobenzidine (DAB) chromogen for 6 min, then submerged under running water to wash gently for 4 min. Tissue sections were counterstained with hematoxylin (staining time will depend on the age of the hematoxylin) from 15 sec to 90 sec at room temperature. Slides were washed under running water for 3 min to remove excess counterstain, dehydrated in alcohol baths (about 10 sec in each) from 85% to 100%, cleaned in xylene, and coverslipped.

Better antigen reactivity has been shown for progesterone receptor, factor VIII-related antigen, CD-31, CD-68, cytokeratin-7, chromogranin, and smooth muscle antigen, probably because of better preservation of antigen (e.g., greater signal-to-noise ratio).

| Reagents | Catalog # | Source |
|---|---|---|
| Microscope slides - snow coat | 00206 | Surgipath |
| X-TRA | | |
| Elite ABC Kit (standard) | PK-6100 | Vector Labs. |
| Biotinylated anti-mouse IgG (H&L) | BA-2000 | Vector Labs. |
| Biotinylated anti-mouse IgM (H&L) | BA-2020 | Vector Labs. |
| Biotinylated anti-mouse/anti-rabbit | BA-6000 | Vector Labs. |
| IgG (H&L) | | |
| Normal horse serum (NHS) | S-2000 | Vector Labs. |
| Diaminobenzidine tetrahydrochloride | K3466 | DAKO Corp. |
| Potassium phosphate (monobasic) | 7100-500 NY | Baxter Scientific |
| Sodium phosphate (dibasic) | 7917-2.5 NY | Baxter Scientific |
| Sodium chloride (AR Crystals) | 7581-2.5 NY | Baxter Scientific |
| 30% Hydrogen peroxide | 5240-500 NY | Baxter Scientific |
| Xylene | 8644-20 NY | Baxter Scientific |
| Harris hematoxylin | S-7735-3 | Baxter Scientific |
| Methyl alcohol | 3016-20 NY | Baxter Scientific |
| 95% Alcohol | | Florida Distillers |
| Absolute Ethyl Alcohol | | Florida Distillers |

| | | |
|---|---|---|
| Rabbit (R) | Microwave (M) | 30′ Incubation |
| Mouse (MIgG) | Trypsin (T) | 45′ Incubation |
| Mouse (MIgM) | Protease (P) | 90′ Incubation |
| Goat (G) | Fast Green (FG) | |

| | | Special | Incub. | Linking |
|---|---|---|---|---|
| Abbrev. | Antibody | Procedure | Time | Sol. |
| (ACTH) | Adrenocorticotropin Hormone | 1:2000 | 30′ | R |
| (AACT) | Alpha-1 Antichymotrypsin | 1:50000 | 30′ | R |
| (AAT) | Alpha-1 Antitrypsin | 1:2000 | 30′ | R |
| (ADENO) | Adenoviurs | 1:1000 | 30′ | MIgG |
| (AFP) | Alpha Fetoprotein | 1:2500 | 30′ | R |
| (AEI/3) | Cytokeratin | 1:200(M) | 45′ | MIgG |
| (ALA) | Alpha Lactalbumin | 1:600 | 30′ | R |
| (ACTIN) | Actin Muscle | 1:200 | 30′ | MIgG |
| (APP-A4) | Anti-Alzheimer Precursor Protein | 1:500(M) | 45′ | MIgG |
| | A4 | | | |
| (ASPE) | Aspergillus | 1:500 | 30′ | R |
| (AR) | Androgen Receptor | 1:20(M) | 45′ | MIgG |
| | | (FG) | | |
| (BCA) | B-Cell | 1:200 | 30′ | MIgG |
| (bcl-2) | Anti-Human Oncoprotein | 1:100(M) | 45′ | MIgG |
| (BerEp4) | Human Epithelial Antigen | 1:25 | 30′ | MIgG |
| (B72.3) | TAG72 Tumor-Associated | 1:100 | 30′ | MIgG |
| | Glycoprotein 72 | | | |
| (BLA36) | B Lymphocyte Antigen | 1:100 | 30′ | MIgG |
| (CMV) | Cytomegalovirus | 1:50(P) | 30′ | MIgG |
| (CHRG) | Chromogranin | 1:50 | 30′ | MIgG |
| (CALC) | Calcitonin | 1:2000 | 30′ | R |
| (CEA) | Carcinoembryonic Antigen | 1:6000 | 30′ | R |
| (CERb′B2) | c-erbB-2 Oncogene Mab1 | 1:1500 | 90′ | R |
| (CATH) | Cathepsin D | 1:2000(M) | 45′ | R |
| (CAM 5.2) | Cytokeratin | 1:500(M) | 45′ | R |
| (CK 7) | Cytokeratin | 1:200(M) | 45′ | MIgG |
| (CK 20) | Cytokeratin | 1:25(M) | 45′ | MIgG |
| (COLL IV) | Collagen IV | 1:25(P) | 30′ | MIgG |
| (CA 125) | Anti-Human CA 125 (MII) | 1:20(M) | 45′ | MIgG |
| (CD 30) | Anti-Human Ki-1 Antigen | 1:200(M) | 45′ | MIgG |
| | (BER-H2) | | | |
| (ER) | Estrogen Receptor | 1:50(M)(FG) | 45′ | MIgM |
| (FVIII) | Von Willebrand Factor | 1:50(P) | 30′ | MIgM |
| (FSH) | Follicle Stimulating Hormone | 1:3000 | 30′ | R |
| (5 HT) | Serotonin | 1:50 | 30′ | MIgM |
| (FXIII) | Anti-coagulation Factor | 1:1200 | 30′ | R |
| (GAST) | Gastrin | 1:2000 | 30′ | MIgM |
| (GFAP) | Glial Fibrillary Acidic Protein | 1:1500 | 30′ | R |
| (GLUC) | Glucagon | 1:10000 | 30′ | R |
| (GH) | Growth Hormone | 1:5000 | 30′ | R |
| (GCDFP) | Gross Cystic Disease Fluid | 1:250 | 30′ | MIgM |
| | Protein | | | |
| (GRP) | Gastrin-Releasing Peptide | 1:1000 | 30′ | R |
| (HMWK) | High Molecular Weight | 1:10 | 45′ | MIgM |
| | Keratin (34βE12) | | | |
| (Hbcore) | Hepatitis B Core Antigen | 1:5000 | 30′ | R |
| (HBsAg) | Hepatitis B Surface Antigen | 1:100 | 30′ | MIgM |
| (HSV I) | Herpes Simplex Type I | 1:10 | 30′ | R |
| (HSV II) | Herpes Simplex Type II | 1:10 | 30′ | R |
| (HCG) | Human Chorionic | 1:50000 | 30′ | R |
| | Gonadotropin | | | |
| (HPL) | Human Placental Lactogen | 1:100000 | 30′ | R |
| (HIST) | Histoplasma | 1:1000 | 30′ | R |
| (H.Pyl) | Heliobacter pylori | 1:500(M) | 45′ | R |
| (β-HCG) | β-Human Chorionic | 1:10000 | 30′ | R |
| | Gonadotropin | | | |
| (IgA) | Alpha Heavy Chain | 1:400 | 30′ | R |
| (IgG) | Gamma Heavy Chain | 1:1000 | 30′ | R |
| (IgAs) | Secretory Piece of IgA | 1:200 | 30′ | R |
| (IgM) | Mu Heavy Chain IgM | 1:1000 | 30′ | R |
| (INS) | Insulin | 1:100 | 30′ | R |
| (Ki-67) | Nuclear Antigen MIB-1 | 1:50(M)(FG) | 45′ | MIgG |
| (K) | Kappa Light Chain | 1:200(M) | 45′ | MIgG |
| (KERATIN) | AEI/3 CAM | 1:50/1:500(M) | 45′ | MIgG |
| (LCA) | Leucocyte Common Antigen | 1:50 | 30′ | MIgG |
| (Leu M1) | Leu M1 Antigen | 1:200(M) | 45′ | MIgM |
| (Leu 7) | Leu 7 Antigen | 1:50(M) | 45′ | MIgM |
| (Lectin) | Lectin | 1:4000 | USE INSTEAD | |
| | | | OF NHS | |
| (Anti-Lectin) | Anti-Lectin Antigen | 1:10000 | 30′ | G |
| (LEA 135) | Anti-Human Luminal | 1:50 | 30′ | MIgG |
| | Epithelial Antigen | | | |
| (LH) | Luteinizing Hormone | 1:3000 | 30′ | R |
| (L) | Lambda Light Chain | 1:6000(M) | 45′ | MIgG |
| (LMK-8) | Low Molecular Weight | 1:25(M) | 45′ | MIgG |
| | Keratin | | | |
| (LIP-AS 105) | Lipase | 1:400 | 30′ | MIgG |
| (MCA) | Myeloid Histiocyte Antigen | 1:400(M) | 45′ | MIgG |
| | (MAC 387) | | | |
| (MUR) | Muramidase | 1:2000 | 30′ | R |
| (MYOGL) | Myoglobin | 1:5000 | 30′ | R |
| (MAPH) | Macrophage | 1:50 | 30′ | MIgG |
| (MTLT) | Metallothionein | 1:50 | 30′ | MIgG |
| (MEL) | Melanoma HMB 45 | 1:50 | 30′ | MIgG |
| (MAK 6) | Anti-Cytokeratin | 1:50(T) | 90′ | MIgG |
| (MBP) | Myelin | 1:500 | 30′ | R |
| (MESO) | Mesothelial Antigen | 1:500 | 30′ | MIgM |
| (MAST-C) | Mast Cell | 1:2000(T) | 30′ | MIgG |
| (MPO) | Myeloperoxidase | 1:5000 | 30′ | R |
| (MGN) | Myogenin | 1:15 | 45′ | MIgG |
| (NB) | Neuroblastoma | 1:200 | 90′ | MIgG |
| (N-FIL) | N-Filament (2F11) | 1:250 | 30′ | MIgG |
| (NSE) | Neuron Specific Enolase | 1:4000(M) | 45′ | MIgG |
| (PAMYL) | Pancreatic Amylase | 1:20 | 30′ | MIgG |
| (PCP) | Pneumocystis carinii | 1:25 | 30′ | MIgM |
| (PLAP) | Placental Alkaline | 1:800 | 30′ | R |
| | Phosphatase | | | |
| (PPP) | Pancreatic Polypeptide | 1:3000 | 30′ | R |
| (PTH) | Parathyroid Hormone | 1:250(M) | 45′ | (RAT) |
| (PROL) | Prolactin | 1:500 | 30′ | R |
| (PAPH) | Prostatic Acid Phosphatase | 1:4000 | 30′ | R |
| (PML)(SV40) | Progressive Multifocal | 1:10000 | 30′ | R |
| | Leucoencephalopathy | | | |
| (PR) | Progesterone Receptor | 1:100(M) | 45′ | R |
| (PR 1A6) | Progesterone Receptor | 1:50(M) | 45′ | MIgG |
| (PSA) | Prostate Specific Antigen | 1:750 | 30′ | R |
| (PCNA) | Proliferating Cell Nuclear | 1:100(M)(FG) | 45′ | MIgG |
| (PS2) | PS2 Protein | 1:1000 | 45′ | R |
| (P53) | p53 Antigen | 1:50(M)(FG) | 45′ | MIgG |
| (S100 A) | S100 A Protein | 1:3000 | 30′ | R |
| (S100) | S100 Protein | 1:2000 | 30′ | R |
| (SOMAT) | Somatostatin | 1:3000 | 30′ | R |
| (SYNAP) | Synaptophysin | 1:800(M) | 45′ | R |
| (SMA) | Smooth Muscle Actin | 1:100 | 30′ | MIgG |
| (∝SR-1) | Sarcomeric Actin | 1:100 | 30′ | MIgG |
| (TESTOS) | Testosterone | 1:250 | 30′ | R |
| (TGB) | Thyroglobulin | 1:20000 | 30′ | R |
| (TP-103) | Treponema | 1:50(T) | 30′ | MIgG |
| (TM) | Thrombomodulin | 1:50 | 30′ | MIgG |
| (TSH) | Thyroid Stimulating Hormone | 1:2000 | 30′ | R |
| (TCA) | T-Cell Antigen | 1:800(M) | 45′ | MIgG |
| (TOXO) | Toxoplasma | 1:1000 | 30′ | R |
| (UBT) | Ubiquitin | 1:250 | 30′ | R |
| (VIP) | Vasoactive intestinal peptide | 1:1500 | 30′ | R |
| (VIM) | Vimentin | 1:800(M) | 45′ | MIgG |
| (VZV) | Variecella-Zoster Virus | 1:100 | 30′ | MIgG |
| (WSKER) | Wide Spectrum Keratin | 1:500 | 30′ | R |

### Example 6

### DNA Extraction from Processed Tissue Sections

Two six micron tissue sections were placed in a 1.5 ml microfuge tube, 800 μl xylene was added and mixed by vortexing, 400 μl absolute ethanol was added and mixed by vortexing, the tube was centrifuged for 5 minutes in a high speed microfuge, and the supernatant was decanted. To the pellet, 800 μl absolute ethanol was added and mixed by vortexing.

The supernatant was decanted after centrifugation as above, and 100 82 l of a detergent/proteinase K solution (1% NP40 or Triton X-100, 2.4 μl of 2.5 mg/ml proteinase K) was added to the pellet and incubated at 550 for one hour. Proteinase K was inactivated by incubation at 95° for 10 min. Save the supernatant containing DNA after centrifugation in the microfuge for 5 min. This material is ready for PCR. It should be precipitated and/or extracted further if Southern blotting is planned. More sections would be required to obtain enough DNA for restriction analysis.

### Example 7

### RNA Extraction from Processed Tissue Sections

Ten sections (7 μm each) of a paraffin block were cut using disposable blades; the blocks were prepared according to the present invention and by the conventional procedure. They were placed in 50 ml Falcon tubes, deparaffinized with 20 ml of xylene, and the remaining tissue was then washed twice with absolute alcohol for 30 minutes. The tissue was suspended at 0.5 g/ml in a solution containing 4M guanidinium thiocyanate, 25 mM Na citrate pH 7.0, 0.5% N-laurylsarcosine, and 0.1 M of 2-mercaptoethanol. The solution was mixed by vortexing and DNA was sheared by passage through an 18 to 22 gauge syringe needle.

The RNA-containing solution was carefully layered on 2.8 ml of 5.7 M CsCl in several 5 ml centrifuge tubes (Sorvall), and RNA was sedimented by centrifugation in an SW55Ti rotor at 35,000 rpm and 18° C. for 14 hours in a Beckman L8-53 ultracentrifuge. The top fraction was carefully removed to leave an RNA pellet at the bottom of the tube. The pellet was resuspended with ribonuclease-free water, and the Eppendorf tube was spun at 14,000 rpm for 10 min. The supernatant containing RNA was saved and the UV absorbance was measured: extinction coefficient 1 OD₂₈₀/ cm is 40 μg/ml RNA, OD₂₆₀/OD₂₈₀ ratio should be between about 1.8 and about 2.0. A total of 45 μg RNA was extracted from tissue specimens prepared according to the present invention whereas no RNA was detectable from tissue specimens processed conventionally.

While the present invention has been described in connection with what is presently considered to be practical and preferred embodiments, it is understood that the present invention is not to be limited to the disclosed embodiments but, on the contrary, is intended to cover various modifications and equivalent arrangements included within the spirit and scope of the appended claims. Thus, it is to be understood that variations in the described invention will be obvious to those skilled in the art without departing from the novel aspects of the present invention and such variations are intended to come within the scope of the claims below.

Furthermore, it should be understood that an element contained in this specification should not be construed as a limitation of the claimed invention unless it is explicitly recited in the claims. Thus, the claims are the basis for determining the scope of legal protection granted instead of a limitation from the specification which is read into the claims.

We claim:

1. A system for processing a tissue specimen for histology by hardening and impregnating said tissue specimen to produce an embedded tissue specimen suitable for sectioning, comprising a plurality of modules each comprised of a chemical composition contained within a reaction chamber of at least types (a)-(e):
(a) a first module containing a first solution comprised of a ketone and an alcohol;
(b) a second module containing a second solution comprised of a ketone and an alcohol, wherein concentration of ketone in said second solution is lower than concentration of ketone in said first solution;
(c) a third module containing a third solution comprised of a ketone, an alcohol, and a mineral oil;
(d) a fourth module containing a fourth solution comprised of a mineral oil and another impregnating agent, said another impregnating agent is a wax that would be solid at room temperature;
(e) a fifth module containing a fifth solution comprised of a wax;
(f) an agitator is provided in one or more modules to promote chemical exchange between tissue specimen and solution;
(g) a microwave unit transferring energy to and heating at least the contents of at least three reaction chambers of types (a)-(c);
(h) a heater unit transferring energy to at least one of the contents of at least three reaction chambers of type (d) or (e) to provide radiant heat; and
(i) an armature conveyance travelling between at least two of said plurality of modules which transfers tissue specimens therebetween to transfer tissue specimens from module to module;
wherein each module contains a substantially non-aqueous composition; hardening of said tissue specimen is caused by fixation and dehydration with at least some of said chemicals and said microwave radiation; said tissue specimen is transferred between successive modules in an ordered sequence; and a tissue specimen between about 1 mm and 2 mm in thickness can be hardened, impregnated, and embedded in wax in less than two hours.

2. The system of claim 1, wherein said first solution has a volume ratio of alcohol to ketone in a range between 1:1 and 6:1.

3. The system of claim 2, wherein said first solution is further comprised of polymers between 100 and 500 average molecular weight and a surfactant.

4. The system of claim 1, wherein at least one of said chemical compositions is comprised of a xylene.

5. The system of claim 1, wherein none of said chemical compositions is comprised of a xylene.

6. The system of claim 1, wherein at least one of said reaction chambers is comprised of:
(i) a removable container with walls which are adapted to fit within said at least one of said reaction chambers in close apposition thereto and which are at least partially in contact with the chemical composition contained therein,
(ii) a lid adapted to fit on said removable container and over a surface of the chemical composition contained therein, and
(iii) thermal insulation surrounding said removable container which reduces heat loss from the contents of said at least one of said reaction chambers;
wherein the walls of said removable container and said lid define a total volume; and space between said chemical composition contained within the removable container and said lid is at most 10% of said total volume.

7. The system of claim 1, wherein said microwave unit is comprised of:
(i) a source which generates microwave radiation, and
(ii) a waveguide which transmits the microwave radiation;
wherein said microwave radiation is transmitted from the source to at least three reaction chambers of types (a)-(c) by the waveguide; said at least three reaction chambers have an interior configuration providing a substantially uniform distribution of temperature in their contents; and there is independent control of microwave radiation transmitted to each of said at least three reaction chambers.

8. The system of claim 7, wherein said contents of said at least three reaction chambers are heated to a temperature between 50° C. and 75° C.

9. The system of claim 7, wherein said source is a magnetron generating microwave radiation with a wavelength of about 2450 megahertz.

10. The system of claim 7, wherein said source has a power output which varies between 0 and 1000 watts, and independently transmitted to each of said at least three reaction chambers.

11. The system of claim 7, wherein said interior configuration is a whispering gallery.

12. A system for processing a tissue specimen for histology, comprising a plurality of modules each comprised of a non-aqueous chemical composition contained within a reaction chamber of at least types (a)-(c):
(a) at least one of said plurality of modules containing a solution comprised of a fixative,
(b) at least one of said plurality of modules containing a solution comprised of a dehydrating agent,
(c) at least one of said plurality of modules containing a solution comprised of an impregnating agent,
(d) an agitator is provided in one or more modules to promote chemical exchange between tissue specimen and solution,
(e) a microwave unit transferring energy to and heating at least the contents of the reaction chambers of types (a)-(b),
(f) a heater unit transferring energy to at least one of the contents of a reaction chamber of type (c) to provide radiant heat, and
(g) an armature conveyance travelling between at least two of said plurality of modules which transfers tissue specimens therebetween to transfer tissue specimens from module to module;
wherein said chemical compositions contained in reaction chambers of types (a)-(c) are substantially non-aqueous; and wherein a first tissue specimen is transferred from a type (a) reaction chamber to a type (c) reaction chamber, and then a second tissue specimen is transferred to a type (a) reaction chamber before the first tissue specimen is transferred from the module of type (c) in an ordered sequence.

13. The system of claim 12, wherein at least one of said reaction chambers is comprised of:
(i) a removable container with walls which are adapted to fit within said at least one of said reaction chambers in close apposition thereto and which are at least partially in contact with the chemical composition contained therein,
(ii) a lid adapted to fit on said removable container and over a surface of the chemical composition contained therein, and
(iii) thermal insulation surrounding said removable container which reduces heat loss from the contents of said at least one of said reaction chambers;
wherein the walls of said removable container and said lid define a total volume; and space between said chemical composition contained within the removable container and said lid is at most 10% of said total volume.

14. The system of claim 12, wherein said microwave unit is comprised of:
(i) a source which generates microwave radiation, and
(ii) a waveguide which transmits the microwave radiation;
wherein said microwave radiation is transmitted from the source to at least two reaction chambers of types (a)-(b) by the waveguide; said at least two reaction chambers have an interior configured as a whispering gallery; and there is independent control of microwave radiation transmitted to each of said at least two reaction chambers.

15. The system of claim 14, wherein said contents of said at least two reaction chambers are heated to a temperature between 50° C. and 75° C.

16. The system of claim 14, wherein said source is a magnetron generating microwave radiation with a wavelength of 2450 megahertz.

17. The system of claim 14, wherein said source has a power output which varies between 0 and 1000 watts, and independently transmitted to each of said at least two reaction chambers.

18. The system of claim 12, wherein said contents of at least one reaction chamber of type (c) are heated to a temperature greater than 65° C.

19. The system of claim 12, wherein processing of a tissue specimen is completed in less than two hours.

20. The system of claim 12, wherein processing of a tissue specimen is completed in less than 1.5 hours.

21. The system of claim 12, wherein there are at least between three and nine different modules.

22. The system of claim 21, wherein there are at least nine different modules containing at least five different chemical compositions.
